(19) United States
(12) Patent Application Publication
(10) Pub. No.: US 2017/0321794 A1
(43) Pub. Date: Nov. 9, 2017

(54) FLUID SUPPLY DEVICE FOR A TRANSMISSION FOR A MOTOR VEHICLE

(71) Applicant: GETRAG Getriebe- und Zahnradfabrik Hermann Hagenmeyer GmbH & Cie KG, Untergruppenbach (DE)

(72) Inventors: Alexander Kiehlneker, Flein (DE); Martin Seufert, Steinheim (DE); Christian Anzt, Oberstenfeld (DE); Güenter Rüehle, Löechgau (DE); Markus Weidner, Murrhardt (DE); Pawel Loskot, Cleebronn (DE)

(21) Appl. No.: 15/432,433

(22) Filed: Feb. 14, 2017

Related U.S. Application Data
(63) Continuation of application No. PCT/EP2015/068909, filed on Aug. 18, 2015.

(30) Foreign Application Priority Data
Aug. 18, 2014 (DE) 10 2014 111 721.2

(51) Int. Cl. F16H 57/04; F04C 15/00; F04C 2/10; F04C 11/00; F16H 61/00; F16H 3/00

(52) U.S. Cl. CPC F16H 57/0434; F04C 11/008; F04C 15/0015; F16H 61/0031; F04C 2/10; F04C 15/008; F04C 2240/40; F16H 3/006; F04C 2240/30

(57) ABSTRACT

A fluid supply device for a transmission of a motor vehicle. The fluid supply device comprises at least one fluid supply device housing. At least one pump and at least one electric motor are integrated in the fluid supply device housing. The fluid supply device is configured in a modular fashion.

### CROSS-REFERENCE TO RELATED APPLICATIONS

This is a Continuation application of International patent application PCT/EP2015/068909, filed Aug. 18, 2015, which claims the priority of German patent application DE 10 2014 111 721.2, filed Aug. 18, 2014, the entire content of these earlier applications are incorporated herein by reference.

### FIELD

The present invention concerns a fluid supply device for a transmission of a motor vehicle, a transmission for a motor vehicle, and a method for installing a fluid supply device for a transmission.

### BACKGROUND

Numerous fluid supply devices, transmissions and methods for installing fluid supply devices are known from the prior art.

DE 10 2011 122 878 A1 for example describes a pressure source for an electro-fluidic actuation or supply device of a motor vehicle power train. The pressure source comprises a fluid pump, an electric motor driving the fluid pump, and a housing with a first housing part and a second housing part which are connected together via a separating joint. The fluid pump is arranged on the first housing part in the vicinity of the separating joint.

DE 10 2012 016 591 A1 describes a method for determining the temperature of a fluid in a hydraulic arrangement for a motor vehicle. The hydraulic arrangement has a pump arrangement driven by means of a drive motor, and a pressure sensor connected to a pressure port of the pump arrangement for measuring the pressure of the fluid. The pump arrangement is connected to a tank via a leakage point. The temperature of the fluid is determined on the basis of a correlation, specific to the hydraulic arrangement, between a status variable of the drive motor and the temperature of the fluid at a predefined pressure of the fluid.

DE 10 2008 037 235 A1 describes a hydraulic circuit, in particular to control at least one friction clutch of an automatic or automated motor vehicle transmission, and/or the engagement and disengagement of the gears of such a transmission, with a fluid flowing for at least part of the time in the hydraulic circuit. The hydraulic circuit comprises at least one working cylinder with at least one pressure control valve, in particular with a pressure control valve per working cylinder, to control the pressure in the working cylinder. The hydraulic circuit furthermore comprises at least one leakage point, wherein the leakage point can be shut off via a leakage valve. In order to provide a hydraulic circuit which can be controlled rapidly and precisely, with a high power density, the leakage point is formed synthetically and functionally active between the working cylinder and the pressure control valve.

EP 2 557 336 A2 describes a dual clutch transmission with a hydraulic control system. The hydraulic control system of the dual clutch transmission comprises at least one first and one second hydraulic clutch. To activate the hydraulic clutches, the hydraulic medium is pressurized. To ensure that the regulation is as efficient as possible, proportional control valves amongst others are fitted in the control system of the dual clutch transmission.

The devices and methods known from the prior art have numerous disadvantages.

For example, a leakage point may take up additional space, for example in a transmission casing.

Furthermore, usually in the devices known from the prior art, a plurality of hydraulic lines may be provided in the transmission casing. Leakage points which for example may comprise at least one orifice can constitute a non-negligible cost factor.

Furthermore, in the devices and methods known from the prior art, it may be very complicated to install and/or exchange certain elements, for example an actuator.

### SUMMARY

Therefore a fluid supply device is proposed for a transmission of a motor vehicle, a transmission for a motor vehicle, and a method for installing a fluid supply device of a transmission, which at least largely avoid the disadvantages of the known devices and methods.

The fluid supply device for a transmission of a motor vehicle comprises at least one fluid supply device housing. The fluid supply device may comprise for example at least one actuator, preferably at least one pump actuator. The fluid supply device may for example comprise a hydraulic control circuit, for example to actuate at least one clutch, in particular at least one dry clutch and/or at least one wet clutch. The fluid supply device may for example be configured to supply a clutch with a fluid, for example from a fluid sump, in a controlled fashion.

The phrase “in a controlled fashion” in the context of the present invention means for example that a fluid pressure at the clutch may be set and/or changed in a defined fashion.

The term “supply” in the context of the present invention means for example a supply with fluid, in particular for cooling and/or lubrication, and/or for hydraulic control, in particular for actuation.

The fluid may be an arbitrary liquid and/or an arbitrary gas. Preferably, the fluid may be a liquid. For example, the fluid may comprise at least one lubricant and/or at least one coolant. Particularly preferably, the fluid may be oil, for example a lubricating oil and/or a cooling oil.

The fluid supply device may for example comprise several fluid supply device housings, for example two fluid supply device housings. The fluid supply device housing may for example be a device which physically delimits the fluid supply device from an environment. The fluid supply device housing may in principle comprise at least one solid body, for example a metal, preferably aluminum. The fluid supply device housing may for example consist of the metal, preferably aluminum.

The fluid supply device may be configured to conduct and/or pump fluid from the fluid sump to the clutch, or load said fluid with a pressure, in particular a fluid pressure.

At least one pump and at least one electric motor are integrated in the fluid supply device housing.

The fluid supply device may for example comprise at least one valve.

For example, at least one valve, in particular two valves, may be integrated in the fluid supply device housing.

For example, at least two pumps may be integrated in the fluid supply device housing.

For example, the fluid supply device may comprise two or three pumps. In particular, two or three pumps may be integrated in the fluid supply device housing.

For example, the fluid supply device may comprise two or three electric motors. In particular, two or three electric motors may be integrated in the fluid supply device housing.

One pump may be used for example for cooling and/or lubrication, and/or two pumps may also be used for actuation of a respective clutch.

The fluid supply device may in particular be configured to actuate two clutches and/or to cool two clutches.

The term “integrated” in the context of the present invention may mean that the element, for example the pump and/or the electric motor, is substantially and preferably completely physically contained by the fluid supply device housing.

The pump may for example be a device which is configured to convert electrical energy into mechanical energy, preferably hydraulic energy. The pump may be configured to load the fluid, in particular oil, with a pressure and/or a volume flow.

The pump may have at least one external rotor and/or at least one internal rotor. The pump may for example be a gerotor pump.

The pump may for example be a unidirectional pump. Alternatively, the pump may be a bidirectional pump. The bidirectional pump may be operated in at least one pumping direction and in at least one suction direction. The pumping direction may for example point from the pump to a consumer, for example to the clutch. The suction direction may preferably be opposite the pumping direction. The electric motor may preferably be configured to operate the pump.

The electric motor may for example comprise at least one stator and/or at least one rotor and/or at least one electric motor shaft.

The fluid supply device is configured in modular fashion. The fluid supply device may for example be arranged reversibly in and/or on the transmission. The term “reversible” may for example mean that the fluid supply device can be separated from the transmission or from the remaining part of a transmission at least partially, preferably completely, as frequently as required. The fluid supply device may for example be a module. The fluid supply device may for example be configured to be installed and/or removed without releasing a further element, e.g. from a transmission. The fluid supply device may for example be able to be fitted and/or attached, for example in and/or onto the transmission, within a few minutes, preferably within a few seconds.

The fluid supply device may preferably be configured compactly. The fluid supply device may preferably be configured as a stable and/or solid object. The fluid supply device may in particular be configured integrally.

The fluid supply device may for example be configured compactly. The fluid supply device may for example have a volume of between 10 cm³ and 1000 cm³, preferably between 100 cm³ and 500 cm³, particularly preferably between 300 cm³ and 400 cm³.

For example, the fluid supply device may be configured substantially cylindrically. For example, the fluid supply device may have a diameter of 10 mm to 100 mm, preferably of 50 mm to 70 mm, particularly preferably of 66 mm. For example, the fluid supply device may have a height of 10 mm to 500 mm, preferably of 50 mm to 200 mm, particularly preferably of 95 mm.

The fluid supply device may for example be a plug-in module. The fluid supply device may for example have at least one fixing element, for example at least one screw, preferably for being fixed in the transmission or on the transmission.

The fluid supply device may for example be configured to conduct fluid from a reservoir, for example from a fluid sump, to a consumer, for example a clutch. The fluid supply device may have at least one closed fluid circuit. Alternatively or additionally, the fluid supply device may have at least one fluid passage.

At least one sensor, in particular at least one pressure sensor and/or at least one temperature sensor, may be integrated in the fluid supply device housing. The sensor may in principle be any arbitrary device which is configured to detect at least one physical parameter, for example a physical parameter of a fluid. The physical parameter may for example be selected from a pressure of the fluid and/or a pressure difference of the fluid; a temperature, for example a temperature of the fluid; a viscosity, for example a viscosity of the fluid; a volume flow; a flow speed; a rotation speed of the pump or a rotational frequency of the pump; and a position of a shaft, for example a position of a shaft of the pump. The sensor may for example be an incremental sensor.

For example, the sensor, in particular the incremental sensor, may be configured to detect at least one property of the electric motor and/or of the pump. In particular, the sensor may be configured to detect at least one position of the electric motor and/or the pump, for example a rotor position, and/or at least one rotation speed of the electric motor and/or the pump.

For example, the fluid supply device may be configured to conclude, from a temporal development of the position detected by the sensor, the rotation speed of the electric motor and/or a rotation speed of the pump.

The sensor, in particular the incremental sensor, may for example have at least one Hall sensor, preferably to detect the position and/or the temporal development of the position of the rotor and/or the rotation speed of the electric motor and/or the pump.

Alternatively or additionally, the rotation speed of the electric motor and/or the rotation speed of the pump may be detected inductively.

The sensor, in particular the temperature sensor, may for example be configured to improve a control of the fluid supply device, in particular the pump actuator. The temperature sensor may for example be configured to detect the temperature of the fluid, for example an inflowing fluid flow. For example, if the temperature of the fluid, e.g. of the inflowing fluid flow, is known, a pressure of the fluid can be controlled and/or regulated better. Preferably, the temperature sensor may be arranged at a suction port and/or be configured to detect the temperature of the fluid at the suction port.

At least one filter may be integrated in the fluid supply device housing. The filter may for example be a pressure filter and/or a suction filter.

For example, the fluid supply device may comprise at least one pressure filter and/or at least one suction filter, preferably inside the fluid supply device housing. The filter may for example be configured to prevent and/or alleviate a contamination of the fluid. The suction filter may for example be arranged in front of the pump. The suction filter may in particular be configured to filter aspirated fluid. The pressure filter may preferably be arranged behind the pump. The pressure filter may for example be configured to protect an orifice from dirt. The pressure filter may preferably be arranged in front of an orifice.

The filter may for example have at least one sieve. In particular, the filter may be a sieve.

Alternatively, the filter may be arranged fully or at least partially outside the fluid supply device housing.

At least one electrical unit may be integrated in the fluid supply device housing. The electrical unit may comprise at least one electronic unit and/or electrical hardware and/or an actuator, for example a control unit, and/or at least one wiring harness and/or at least one circuit board and/or at least one interface and/or at least one plug connector.

The plug connector may preferably be arranged laterally on the fluid supply device housing. Particularly preferably, the plug connector may be arranged on a casing of a housing pot and/or on a housing cover.

The housing cover may preferably have an electrical line between the valve and/or a sensor, in particular the combined temperature-pressure sensor, and the plug connector. The plug connector, like the valve and/or the combined temperature-pressure sensor, may preferably be arranged laterally to the rotation axis of the pump.

The fluid supply device may preferably have at least one cable passage. The cable passage may for example be integrated in the fluid supply device housing. The cable passage may for example connect at least one sensor and/or the electric motor to the electrical unit.

The fluid supply device housing may have at least one housing pot and at least one housing cover. The fluid supply device housing may for example be a component housing. The housing cover may be connected to the housing pot, preferably permanently connected. For example, the housing cover may be welded and/or caulked to the housing pot. For example, the housing cover may be connected to the housing pot by means of at least one closing device. Alternatively, the housing cover may be reversibly connected to the housing pot, in particular by means of at least one closing device. The housing pot and/or housing cover may for example be configured substantially cylindrically and/or pot-like. The housing pot and/or the housing cover may have at least one floor. In addition, the fluid supply device housing may have at least one housing center piece. The housing center piece may for example be configured in a tubular fashion. The housing pot and/or the housing cover and/or the housing center piece may comprise at least one flange and/or at least one thread and/or at least one screw connection and/or at least one clamp connection, in particular such that the fluid supply device housing can be closed, preferably reversibly closed and/or opened.

The fluid supply device housing may for example have at least two mutually connected housing parts.

The housing parts may for example be separate housings which, at least at one point, may be connected to at least another housing part of the fluid supply device housing.

The housing parts may for example have openings, in particular at connections to other housing parts.

The housing part may be integrated fully or partly in the fluid supply device housing.

At least one of the housing parts may form at least partially an outer wall of the fluid supply device housing.

The housing parts may be connected together in modular fashion and thus form the fluid supply device housing. The housing parts may for example be at least partially nested together. At least one of the housing parts may be integrated at least partially in at least one other housing part.

The fluid supply device housing may for example have at least two housing pots as housing parts. The housing pots may for example be nested together.

For example, at least one power electronics unit may be integrated in the fluid supply device housing. For example, the power electronics may be integrated in a housing part of the fluid supply device housing. Preferably, the power electronics may be integrated in the housing cover.

Alternatively or additionally, at least one electrical line may be integrated in the housing cover.

Alternatively, the power electronics may also be arranged in a separate housing.

For example, the sensor, in particular the pressure sensor and/or the temperature sensor, preferably the combined temperature-pressure sensor, may be connected at least at one side to an electrical line.

The electrical line may for example be arranged on an axial side, i.e. substantially parallel to the rotation axis of the pump, the sensor, in particular the pressure sensor and/or temperature sensor, preferably the combined temperature-pressure sensor.

Alternatively, the electrical line may be arranged for example on a radial side, i.e. substantially perpendicular to the rotation axis of the pump, the sensor, in particular the pressure sensor and/or the temperature sensor, preferably the combined temperature-pressure sensor.

The fluid supply device housing may preferably have at least one housing part comprising the electric motor, for example an electric motor housing part, and at least one housing part comprising the pump, for example a pump housing part. The housing part comprising the electric motor and the housing part comprising the pump may preferably be connected together, in particular via at least one opening of the housing part comprising the pump and at least one opening of the housing part comprising the electric motor.

Preferably, the electric motor and/or at least one sensor, preferably at least one incremental sensor, may be integrated in the electric motor housing part.

The pump housing part may integrate the pump and/or at least one fluid line and/or at least one electrical line and/or at least one sensor, for example at least one temperature sensor and/or at least one pressure sensor and/or at least one combined temperature-pressure sensor and/or at least one incremental sensor, and/or at least one orifice and/or at least one valve and/or at least one internal leakage and/or at least one external leakage.

The pump housing part may preferably have the form of a cylinder. For example, the pump housing part may have at least one lateral arm. In particular, the arm may integrate at least one temperature sensor and/or at least one pressure sensor and/or at least one orifice and/or at least one fluid line and/or at least one electrical line and/or at least one valve.

Alternatively or additionally, the fluid supply device housing may have at least one housing part comprising at least one line, in particular at least one line housing part, and/or at least one housing part comprising at least one valve, in particular at least one valve housing part. The line may for example be an electrical line, in particular a current and/or voltage supply line and/or a signal line, and/or a fluid line.

The line housing part may protrude axially over the pump housing part.

For example, the electric motor housing part and/or the pump housing part and/or the line housing part and/or the valve housing part may be configured as one housing part.

The electric motor housing part and/or the pump housing part and/or the line housing part and/or the valve housing part may be integrated fully or partially in the fluid supply device housing.

For example, the electric motor housing part and/or the pump housing part and/or the line housing part and/or the valve housing part may at least partially form an outer wall of the fluid supply device housing.

For example, the sensor, in particular the pressure sensor and/or the temperature sensor, preferably the combined temperature-pressure sensor, may be connected at least on one side to a fluid line.

The fluid line may for example be arranged on an axial side, i.e. substantially parallel to the rotation axis of the pump, the sensor, in particular the pressure sensor and/or temperature sensor, preferably the combined temperature-pressure sensor.

Alternatively, the fluid line may be arranged for example on a radial side, i.e. substantially perpendicular to the rotation axis of the pump, the sensor, in particular the pressure sensor and/or the temperature sensor, preferably the combined temperature-pressure sensor.

At least some of the housing parts may for example be bolted together, preferably by means of at least one screw. Alternatively or additionally, at least some of the housing parts may be connected together by push-fit connections, for example by means of at least one fixing hook.

For example, at least the housing part comprising the pump and the housing part comprising the electric motor may be screwed together, in particular by means of at least one screw. The remaining housing parts may be connected together preferably by means of push-fit connections, for example fixed together by means of at least one fixing hook.

The housing parts may at least partially for example have a substantially rotationally symmetrical form, preferably substantially rotationally symmetrical to a rotation axis of the pump.

Particularly preferably, the electric motor housing part and/or the pump housing part may have a form which is substantially rotationally symmetrical about the rotation axis of the pump.

In principle, the housing parts may however at least partially have a form which is not rotationally symmetrical to the rotation axis of the pump.

In particular, at least one housing part of the fluid supply device housing, for example the line housing part and/or the valve housing part and/or at least partially the pump housing part, may be arranged laterally offset to the rotation axis of the pump. For example, at least one housing part, for example the line housing part and/or the valve housing part, may be arranged in the form of a lateral arm. At least one housing part, for example the pump housing part, may comprise a lateral arm.

The fluid supply device housing may for example have the topology of a homeomorph to a torus. The fluid supply device housing for example take the form of a closed cup, wherein the fluid supply device housing preferably has at least two housing parts.

For example, the line housing part and/or the valve housing part and/or the pump housing part may have a form which is not rotationally symmetrical to the rotation axis of the pump. The line housing part and/or the valve housing part may for example be configured as a housing part arranged laterally on the pump housing part and/or on the electric motor housing part.

The housing part may in principle be any arbitrary housing. For example, the housing part may be a sensor housing, for example a temperature sensor housing and/or a pressure sensor housing and/or a housing of a combined temperature-pressure sensor, and/or a filter housing and/or a valve housing and/or an orifice housing and/or an actuator housing.

The housing parts may in particular be arranged in modular fashion. The fluid supply device housing may in particular have a modular composition of at least two housing parts.

The pump housing part and the electric motor housing part may preferably be configured substantially rotationally symmetrically to the rotation axis of the pump. However, for example the housing cover, at least on one radial side, need not be rotationally symmetrical but may have at least one lateral cable passage. Furthermore, for example at least one plug connector and/or at least one sensor, for example at least one temperature sensor and/or at least one pressure sensor, preferably a combined temperature-pressure sensor, may be arranged laterally on the fluid supply device housing, for example on the housing cover. The plug connector and/or the temperature sensor and/or the pressure sensor, preferably the combined temperature-pressure sensor, may be integrated fully or partially in the housing cover. Preferably, the plug connector may be arranged externally on the housing cover, and the temperature sensor and/or pressure sensor, preferably the combined temperature-pressure sensor, may be partially integrated in the housing cover and partially arranged outside the housing cover.

The incremental sensor and the combined temperature-pressure sensor may be connected to the plug connector in particular via at least one cable passage.

The pump housing part may preferably have a lateral opening. Preferably the sensor, in particular the combined temperature-pressure sensor, may be arranged in the lateral opening. The lateral opening of the pump housing part may be connected to the housing cover by means of the line housing part.

The combined temperature-pressure sensor may be arranged partially in the pump housing part and partially in the line housing part.

The line housing part may preferably have an electrical line between the sensor, in particular the combined temperature-pressure sensor, and the plug connector. The plug connector, like the combined temperature-pressure sensor, may preferably be arranged laterally to the rotation axis of the pump.

In particular, an opening may be present between the electric motor housing part and/or the line housing part and/or the pump housing part and/or the housing cover.

The pump housing part may preferably have the form of a cylinder with a bulge on one side. The pump housing part may preferably have an axial opening at the bulge. Preferably the valve and/or the sensor, in particular the combined temperature-pressure sensor, may be arranged in the axial opening. The pump housing part may be connected to the housing cover via the valve housing part.

The combined temperature-pressure sensor and/or the valve may be arranged partially in the pump housing part and partially in the valve housing part.

In particular, an opening may be present between the electric motor housing part and/or the valve housing part and/or the pump housing part and/or the housing cover.

The valve housing part may be at least partially integrated in the housing cover and/or in the pump housing part.

The fluid supply device may comprise at least one fluid interface. The fluid interface may for example offer a facility for at least one fluidic connection between the fluid supply device and a further element, for example the consumer and/or the transmission and/or a part of the transmission and/or the clutch.

The fluid supply device may preferably comprise two fluid interfaces. The fluid supply device may for example comprise two fluid interfaces if it comprises two pumps. The fluid interface may for example be arranged on the pump housing part. The fluid interface may in particular be arranged axially.

The sensor, in particular the combined temperature-pressure sensor, may for example be integrated partially in the housing cover and partially in the pump housing part. Alternatively, the sensor, in particular the combined temperature-pressure sensor, may be integrated partially in the line housing part and partially in the pump housing part.

The sensor, in particular the pressure sensor and/or the temperature sensor and/or the combined temperature-pressure sensor and/or the incremental sensor, may for example be integrated at least partially in the valve housing.

The fluid interface may for example have at least one suction port and at least one pressure port. The suction port may for example be configured to transport fluid aspirated by the pump into the fluid supply device. The pressure pump may for example be configured to supply fluid to at least one element of a transmission, for example a clutch.

The fluid interface and/or the fluid supply device may have at least one sealing element. The sealing element may for example have at least one O-ring and/or at least one sealing lip.

The fluid interface may for example comprise at least one O-ring, preferably several O-rings, for example two O-rings or four O-rings, in particular to seal the fluid interface. The O-ring may for example be a sealing element, in particular an annular sealing element. The O-ring may for example comprise at least one plastic, e.g. rubber.

The fluid interface may have at least one, preferably two connecting pieces. The connecting piece may for example comprise at least one fluid line protruding from the fluid supply device housing, and/or at least one fluid port. The connecting piece may for example be welded to the fluid supply device housing, or the connecting piece may be part of the fluid supply device housing. For example, two O-rings with radii diminishing towards the bottom, in particular nested, may be arranged on the connecting piece.

For example, the connecting piece may taper towards the end remote from the fluid supply device housing. The connecting piece may for example have two pipes with different diameters. The connecting piece may have a smaller diameter at the end remote from the fluid supply device housing than at the outlet of the connecting piece from the fluid supply device housing.

The fluid interface may comprise at least one, preferably two connecting tubes. The connecting tubes may for example be configured to connect the fluid supply device mechanically and/or fluidically to at least one further element, for example an element of the transmission, particularly preferably the clutch and/or the fluid sump.

Alternatively or additionally, the fluid interface may comprise at least one line in the transmission casing.

At least one fluid line may be integrated in the fluid supply device housing.

The suction port and/or the pressure port and/or the connecting piece and/or the connecting tube and/or the line may be oriented substantially parallel to a rotation axis of the pump or substantially perpendicular to the rotation axis of the pump. The term “substantially parallel” may for example mean an angle between an axis of the suction port and/or the pressure port, for example an axis of rotational symmetry of the suction port and/or the pressure port, and the rotation axis of the pump, of 0° to 45°, preferably of 0° to 10°, particularly preferably of 0°. The term “substantially perpendicular” may for example mean an angle between an axis of the suction port and/or pressure port, for example an axis of rotational symmetry of the suction port and/or pressure port, and the rotation axis of the pump, of 45° to 135°, preferably of 80° to 100°, particularly preferably of 90°. The suction port and/or the pressure port may for example be arranged axially, in particular substantially parallel to the rotation axis of the pump, for example on the floor of the housing pot and/or on the floor of the housing cover. Alternatively, the suction port and/or the pressure port may be arranged radially, in particular substantially perpendicular to the rotation axis of the pump, for example on a casing of the housing pot and/or on a casing of the housing cover and/or on the center piece.

An axis of rotational symmetry of the O-ring may for example be arranged substantially perpendicular to the rotation axis of the pump. Alternatively, an axis of rotational symmetry of the O-ring may be arranged substantially parallel to the rotation axis of the pump.

For example, one or two O-rings may be provided for each of the suction port and/or the pressure port. For example, the axes of rotational symmetry of the O-rings may be arranged substantially perpendicular or parallel to the rotation axis of the pump.

The external diameters of the O-rings of the fluid supply device may for example be the same. Preferably, the external diameters of the O-rings may diminish towards the floor of the housing pot, preferably when the O-rings are arranged substantially perpendicular to the rotation axis of the pump, for example to prevent damage to the O-rings on installation and/or on removal. The diameters of the O-rings may for example diminish in steps towards the floor of the housing pot.

For example, the fluid supply device housing may have a form which is composed of truncated cones and/or cylinders with different external diameters, preferably with external diameter diminishing towards the floor of the housing pot. The fluid supply device housing may for example have a conical form.

An outer wall of the fluid supply device housing and/or the connecting piece and/or the tube may for example have at least one peripheral groove and/or at least one peripheral guide channel, in particular for fixing and/or positioning the O-ring or O-rings.

The fluid supply device may comprise at least one internal leakage and/or at least one external leakage. The internal leakage and/or the external leakage may be devices which allow and/or guarantee a continuous through-flow of fluid through at least a part of the fluid supply device, for example through the pump, at least while the pump is in operation.

The internal leakage may in particular comprise the valve, in particular as a controllable internal leakage, and/or an orifice.

The internal leakage and/or the external leakage may for example be configured such that when the fluid pressure is not equal to zero, a fluid flow is always possible, preferably continuously, preferably through the pump.

The internal leakage and/or the external leakage may in particular be configured to supply the clutch with fluid from the fluid sump in a controlled fashion. For example, the internal leakage and/or the external leakage may be configured to regulate a fluid pressure and/or a fluid volume flow. The internal leakage and/or the external leakage may in particular positively influence a characteristic curve of the fluid supply device with respect to controllability. The characteristic curve may for example describe a correlation between a rotational frequency of the pump and a pressure at the clutch.

The external leakage may in particular comprise an outflow of fluid from the pump supply device housing, in particular from the pump housing part. The outflow of fluid may preferably be oriented in the axial direction. Alternatively or additionally, the outflow of fluid may also be oriented in the radial direction.

The internal leakage and/or the external leakage may for example be configured such that a leakage oil flow circulates around and/or cools the electric motor. For example, the leakage oil flow may be conducted radially out of the fluid supply device housing and/or guided around the electric motor in the interior of the fluid supply device housing, for example by means of fluid lines and/or bores inside the fluid supply device housing.

Alternatively or additionally, the leakage oil flow, for example an orifice volume flow, may be supplied directly or indirectly back to the suction port and/or the pump.

An orifice function may for example be integrated in the pump and/or in the fluid supply device, and/or after the pump and/or at the pressure port. The pressure port may for example be a pressure outlet. The orifice function may for example have the function of the internal leakage and/or external leakage, in particular to improve the controllability of a fluid flow through the pump.

Outside the fluid supply device housing, the leakage oil flow may for example be used e.g. to lubricate gearwheels and/or shafts of a transmission.

The fluid supply device housing may for example comprise at least one outflow for fluid from the external leakage. The outflow may for example have at least one opening in the fluid supply device housing.

The internal leakage may have a closed fluid circuit inside the fluid supply device housing and/or inside the pump. The internal leakage may for example have at least one inflow and/or at least one outflow for fluid inside the fluid supply device housing. Preferably, the internal leakage may have no outflow outside the fluid supply device housing.

The external leakage may preferably have an outflow from the fluid supply device housing.

The pump may for example be a gerotor pump. The pump may comprise at least one external rotor and at least one internal rotor. The internal rotor may for example be driven by the electric motor. The external rotor may for example be driven by a rotation of the internal rotor. The pump may furthermore have at least one suction nodule and/or at least one pressure nodule. The suction nodule and/or the pressure nodule may be nodular pump cavities. The suction nodule may for example be connected to the suction port. The pressure nodule may for example be connected to the pressure port. The suction nodule and/or the pressure nodule are preferably configured to influence flows inside the pump.

The internal leakage may for example be integrated in the pump, in particular in the pump geometry. For example, the internal leakage may comprise a fluidic short-circuit in the pump. Alternatively or additionally, the internal leakage may comprise a fluidic short-circuit in the fluid supply device housing, in particular outside the pump.

The internal leakage may for example be configured to integrate an orifice function in the pump itself.

The internal leakage and/or the orifice function may for example be implemented by higher tolerances than usual in the pump. The internal leakage may for example have higher tolerances, in particular greater cavities and/or gaps in the pump than in conventional pumps, in particular a greater head play and/or a greater axial play and/or a greater radial play. The internal leakage may for example comprise gaps at the pump, in particular an axial play and/or a head play and/or a radial play between 1 μm and 1 mm, preferably between 0.01 mm and 0.5 mm, particularly preferably from 0.02 mm to 0.08 mm.

The internal leakage may for example be implemented by at least one chamfer at the pump and/or by at least one groove at the pump, for example by a chamfer and/or a groove on the internal rotor of the pump and/or by a chamfer and/or a groove on the external rotor of the pump. For example, the pump and/or the internal rotor and/or the external rotor may have at least two chamfers and/or at least two grooves. The chamfers and/or the grooves may in particular be arranged symmetrically, in particular such that a symmetrical flow can be achieved. The groove may for example be a peripheral groove. The groove may for example be an inner ring and/or an outer ring. The groove may for example be arranged on a sealing web of the pump, in particular at a chamber passage and/or at a tooth passage. Alternatively or additionally, the groove may be arranged at a pump contact face and/or at a pump floor and/or at a pump housing, for example radially to the rotation axis and/or to the shaft of the pump.

Alternatively, a geometry of the suction nodule and/or a geometry of the pressure nodule may be configured such that this creates an internal leakage necessary for control. The internal leakage may for example comprise a connection between the suction nodule and the pressure nodule. The suction nodule and/or the pressure nodule may preferably have a narrow end and a wide end. The connection between the suction nodule and the pressure nodule may preferably be arranged between the narrow end of the suction nodule and the narrow end of the pressure nodule.

Alternatively or additionally, an internal leakage and/or an orifice function may be implemented by a lateral outflow and/or by a radial cooling outlet.

The orifice function and/or the external leakage may for example be integrated in the fluid supply device housing.

The internal leakage and/or the external leakage may comprise at least one orifice and/or at least one valve and/or at least one filter and/or at least one sensor, in particular at least one pressure sensor and/or at least one temperature sensor. The orifice may for example comprise a fluid line portion with a reduced cross-section. The filter may for example be a pressure filter and/or a suction filter, for example as described above. The sensor may for example be a sensor as described above. The orifice may for example have a diameter of for example 0.1 mm to 5 mm, preferably of 0.5 mm to 0.8 mm, particularly preferably of 0.6 mm to 0.75 mm, depending on application.

For example, at least two orifices and/or at least two valves and/or at least four sensors, in particular at least two pressure sensors and/or at least two temperature sensors and/or at least two combined temperature-pressure sensors and/or at least two incremental sensors may be integrated in the fluid supply device housing, in particular if at least two pumps are integrated in the fluid supply device housing.

The orifice may for example be a controllable orifice.

The valve may for example have the function of a controllable orifice. The fluid supply device may for example be configured to open and/or close the orifice at least partially by means of the valve, for example depending on a driving situation and/or a demand.

If for example fluid is required quickly for at least one consumer of the fluid supply device, for example for at least one clutch, the valve may be closed at least partially. By opening and/or closing the valve to meet demand, for example the rotation speed of the electric motor and/or the rotation speed of the pump can be regulated such that no resonant frequency of the transmission housing is excited and/or amplified, for example at a rotation speed at the kiss point. For example, at low temperatures the valve may be opened further than at high temperatures, in particular to compensate at least partially for temperature-dependent changes in the viscosity of the fluid.

The fluid supply device may for example comprise three pumps and two valves. Two of the pumps may be configured for example to actuate a respective clutch, and one pump may then be configured for cooling, in particular of the clutches. The pump which may be configured for cooling may preferably be designed without a valve, in particular since no control system may be necessary for cooling.

For example, the fluid supply device may comprise precisely one control unit. The control unit may be configured to actuate all pumps and/or all electric motors, for example two or three pumps and/or two or three electric motors. The control unit may furthermore be configured to actuate all valves, for example two valves.

Use of a single control unit for all pumps and/or all electric motors and/or all valves may be advantageous. For example, in this way the number of cables and/or wiring harnesses and/or control units used may be reduced. Furthermore, the construction, for example the final assembly and/or spare part replacement, may be less complicated and/or simpler.

For example, a filter, preferably a sieve, may be arranged between the pump and the valve.

The fluid supply device housing may have at least one housing part comprising the electric motor and/or at least one housing part comprising the pump and/or at least one housing part comprising the sensor, in particular the pressure sensor and/or the temperature sensor, and/or at least one housing part comprising the valve and/or the control system and/or the power electronics, and/or at least one housing part comprising the interface.

The housing parts may preferably be arranged in the order of the housing part comprising the electric motor, the housing part comprising the pump, the housing part comprising the interface, the housing part comprising the valve, the housing part comprising the sensor, in particular the pressure sensor and/or temperature sensor, in particular as a closed arrangement.

For example, the sensor, in particular the pressure sensor and/or the temperature sensor, and the valve may be arranged in one housing part. For example, the above-mentioned order may otherwise be observed with the sensor and the valve in one housing part.

In principle, the housing parts with the respective elements may also be arranged in other orders, and one or more of said elements may be arranged together in one housing part.

The advantages of the arrangement in housing parts may lie in particular in a compact and/or space-saving and/or cost-saving construction.

Preferably, the leakage and/or the internal leakage and/or the external leakage as an orifice function may be integrated in the fluid supply device housing.

The fluid supply device housing may for example have at least one intermediate floor. Preferably, the fluid supply device housing may have at least two intermediate floors. The intermediate floor may be configured to fix the electric motor and/or the pump. The intermediate floor may have at least one opening, preferably a central opening, for passage of the electric motor shaft.

Inside the fluid supply device housing, the electrical unit, the incremental sensor, the electric motor, the pump, the pressure and/or temperature sensor, the filter, the orifice, the suction port and the pressure port may be arranged in said order starting from the housing cover along the rotation axis.

Preferably, the orifice may be arranged directly in the fluid supply device, preferably in an actuator.

In the context of the present invention, the term “orifice” may mean both an orifice plate as a component and an element which has an orifice function, for example an internal leakage.

The pump housing part and/or the line housing part may for example have at least two pumps and/or at least two fluid lines.

The fluid supply device housing may for example have precisely two electric motor housing parts and precisely one pump housing part and precisely two valve housings.

At least two pumps and at least two electric motors may be integrated in the fluid supply device housing. For example, precisely two pumps and precisely two electric motors may be integrated in the fluid supply device housing.

For example, precisely one electrical unit, for example precisely one control unit, may be integrated in the fluid supply device housing. The control unit may be configured to actuate all pumps and/or all electric motors, preferably two pumps and/or two electric motors. The control unit may furthermore be configured to actuate all valves, preferably two valves. The electrical unit may preferably be a power electronics unit.

The fluid supply device may preferably have two fluid interfaces.

The two electric motors and/or the two electric motor housing parts and/or the two valves and/or the two fluid interfaces and/or the two sensors, preferably the two combined temperature-pressure sensors, and/or the two pumps may be arranged symmetrically to a line parallel to the axis. An asymmetry of the fluid supply device may preferably result from the fluid supply device preferably having only one plug connection which in particular may be arranged laterally on the housing cover.

For example, the electric motor and the pump and the pressure sensor and the temperature sensor and the orifice may be integrated in the fluid supply device housing. The electric motor and the pump and the pressure sensor and the temperature sensor and the orifice may be arranged distributed over different housing parts. For example, the power electronics may be integrated in the fluid supply device housing. Alternatively, the fluid supply device housing may be configured without power electronics.

For example, the electric motor and the pump and the pressure sensor and the temperature sensor and the valve may be integrated in the fluid supply device housing. The electric motor and the pump and the pressure sensor and the temperature sensor and the valve may be arranged distributed over different housing parts. For example, the power electronics may be integrated in the fluid supply device housing. Alternatively, the fluid supply device housing may be configured without power electronics.

For example, two electric motors and two pumps and two pressure sensors and two temperature sensors and two orifices may be integrated in the fluid supply device housing. The two electric motors and the two pumps and the two pressure sensors and the two temperature sensors and the two orifices may be arranged distributed over different housing parts. For example, precisely one power electronics unit may be integrated in the fluid supply device housing. Alternatively, the fluid supply device housing may be configured without power electronics or have two power electronics units. For example, two modules each with one electric motor and one pump and one pressure sensor and one temperature sensor and one orifice may here be combined into one large module.

For example, two electric motors and two pumps and two pressure sensors and two temperature sensors and two valves may be integrated in the fluid supply device housing. The two electric motors and the two pumps and the two pressure sensors and the two temperature sensors and the two valves may be arranged distributed over different housing parts. For example, precisely one power electronics unit may be integrated in the fluid supply device housing. Alternatively, the fluid supply device housing may be configured without power electronics or have two power electronics units. For example, two modules each with one electric motor and one pump and one pressure sensor and one temperature sensor and one valve may here be combined into one large module.

In a further aspect, a transmission for a motor vehicle is proposed. The transmission may be a device which comprises at least one gearbox input shaft which can be connected to an engine of the motor vehicle, and at least one gearbox output shaft which can be connected to drive wheels of the motor vehicle when the transmission has been installed.

The transmission may for example be a dual clutch transmission. For example, the transmission may be a hybrid transmission comprising at least one electrical machine.

The transmission, in particular the dual clutch transmission, may for example be an automated manual transmission. The dual clutch transmission may for example allow, by means of two partial transmissions, fully automatic gear changes without interruption of torque. The dual clutch transmission may for example have at least one input shaft. The dual clutch transmission may comprise at least one first clutch, preferably a first friction clutch, and at least one second clutch, preferably a second friction clutch. The dual clutch transmission may have at least one first output shaft and at least one second output shaft. Input elements of the friction clutches may be connected to the input shaft. Output elements of the friction clutches may each be connected to one of the two output shafts. The friction clutches may each be actuatable by means of a piston/cylinder arrangement.

The transmission comprises at least one fluid supply device as described above. Preferably, the transmission may comprise at least two fluid supply devices according to the invention, for example a first fluid supply device for a first clutch and a second fluid supply device for a second clutch. The first fluid supply device may be configured to actuate the first clutch. The second fluid supply device may be configured to actuate the second clutch. In addition, the transmission may have a third fluid supply device. The third fluid supply device may be configured to cool the first clutch and/or the second clutch.

The transmission comprises at least one fluid sump. The fluid sump may for example be an oil sump. The fluid sump may be a device which is configured to receive the fluid, in particular oil. The fluid sump may for example be configured such that it receives fluid, such that gearwheels of the transmission can be supplied with fluid, for example for cooling and/or lubrication. The fluid sump may preferably be a transmission sump. The fluid sump may for example comprise at least one container and/or at least one cavity in the transmission, preferably in a lower part of the transmission, in which the fluid, in particular the oil, collects because of gravity and/or centrifugal force, for example in a rest state of the transmission. The fluid sump may comprise at least one tank.

The transmission comprises at least one clutch. The clutch may be a device which is configured to allow a reversible force transfer between at least two shafts. The term “reversible” may mean that a fluid transmission between the two shafts may be allowed and/or prevented arbitrarily frequently, for example controlled by a driver and/or by an automated control system.

The clutch may preferably be a wet clutch. A wet clutch may preferably be supplied with fluid such that it is cooled by the fluid. In addition, the wet clutch may be actuated by fluid. In particular, the wet clutch may be opened and/or closed by hydraulic actuation, in particular such that a force transmission between the two shafts may be allowed and/or prevented.

Alternatively, the clutch may also be a dry clutch. The dry clutch may for example be opened or closed by hydraulic actuation, in particular such that a force transmission between the two shafts is allowed or prevented.

The fluid supply device is configured to supply the clutch with fluid from the fluid sump in a controlled fashion. The phrase “in a controlled fashion” in the context of the present invention may for example mean that a fluid pressure at the clutch may be set and/or changed in a defined fashion.

The fluid supply device may be configured to conduct and/or pump fluid from the fluid sump to the clutch, and/or load it with a pressure, in particular a fluid pressure.

The transmission may comprise at least one transmission casing. The transmission casing may be a device in which at least one gearwheel set and/or at least one input shaft and/or at least one output shaft may be received at least partially. The transmission casing may preferably be formed separately from the fluid supply device housing. The transmission casing may for example be a casting. The fluid sump may for example be at least partially a part of the transmission casing.

The transmission casing may for example be configured separately from the fluid supply device housing. The fluid supply device housing may for example be mounted at least partially on and/or in the transmission casing.

The fluid supply device housing may be arranged at least partially inside the transmission casing. For example, the fluid supply device housing may be arranged completely inside the transmission casing.

Preferably, the fluid supply device housing may be arranged partially inside the transmission casing. For example, at least the housing cover may be arranged outside the transmission casing, and at least the housing pot may be arranged inside the transmission casing.

Preferably, the transmission casing and the fluid supply device housing may be connected and/or be able to be connected together mechanically and/or fluidically and/or electrically. Preferably, the transmission casing and the fluid supply device housing may be connected and/or be able to be connected together reversibly mechanically and/or reversibly fluidically and/or reversibly electrically.

The transmission casing may for example comprise at least one recess, wherein the fluid supply device may be received at least partially in the recess. The recess may for example be a cavity and/or a depression in the transmission casing. The recess may for example be a bore in the transmission casing. The recess may have at least one interface. The recess may for example have at least one fluid interface and/or at least one information interface and/or at least one electrical interface.

The transmission casing may preferably comprise precisely one recess. The fluid supply device may be received at least partially in the recess.

For example, only the housing cover and/or the plug connector and/or a part of the housing cover and/or of the plug connector may be arranged outside the recess.

At least one O-ring, preferably two O-rings, may be arranged between the transmission casing and the fluid supply device housing. For example, an O-ring may be placed on the face of the transmission casing and of the fluid supply device housing respectively, between the transmission casing and the fluid supply device housing.

The transmission casing may have one or more devices for cooling the electric motor. The device for cooling the electric motor may for example comprise a water cooling system and/or an air cooling system.

The device for cooling the electric motor may for example have an opening in the transmission casing towards the fluid supply device housing. The device for cooling the electric motor may for example have an opening in the fluid supply device housing.

The fluid supply device housing may be fixed on and/or in the transmission casing by means of at least one fixing device. The fixing device may be at least one screw and/or at least one nut and/or at least one thread and/or at least one guide rail and/or at least one clamping device. Preferably, the fluid supply device housing may be fixed, in particular reversibly, to the transmission casing at the closure device of the fluid supply device by means of the fixing device.

The fluid supply device housing may be fixed to the transmission casing for example with at least two screws, preferably with five screws. The screw or screws may for example be fixed to the housing cover.

The transmission casing may comprise at least one bore for a pressure port and/or at least one bore for a suction port. Preferably, the transmission casing may have at least one bore for a pressure port and at least one bore for a suction port.

The transmission may comprise, outside the fluid supply device housing, at least one sensor, in particular at least one pressure sensor and/or at least one temperature sensor, and/or at least one filter, in particular at least one pressure filter and/or at least one suction filter, and/or at least one leakage. The sensor and/or the filter may be configured as described above.

Preferably, the transmission may have, outside the fluid supply device housing, at least one pressure filter and/or at least one suction filter.

Preferably, at least one filter, preferably a suction filter, may be arranged between the fluid sump and the fluid supply device. At least one filter, in particular a high-pressure filter, may be arranged between the fluid supply device and the clutch. For example the sensor, in particular the pressure sensor and/or the temperature sensor, may be arranged between the pump and the clutch and/or the filter, in particular the high-pressure filter, wherein the sensor, in particular the pressure sensor and/or the temperature sensor, may be arranged inside or outside the fluid supply device housing.

In a further aspect, a method is described for installing a fluid supply device of a transmission as described above. The method may for example be performed by hand or by a device, for example a robot.

The fluid supply device is inserted in a transmission casing and at least one fluid interface of the fluid supply device is fluidically connected to the transmission casing. For example, the fluid supply device may be inserted in a transmission casing as described above, and at the same time or before or after, at least one fluid interface and/or at least one electrical interface of the fluid supply device may be fluidically and/or electrically connected to the transmission casing. For example, the fluid supply device may be screwed, preferably as a module, onto the transmission casing. Alternatively, the fluid supply device may be pressed into a bore of the transmission casing.

The fluid supply device may be removed as a single module, for example in a vehicle, for example in a vehicle workshop, preferably without the need to remove further elements of the transmission and/or the vehicle.

The fluid supply device described above for a transmission of a motor vehicle, the transmission described above for a motor vehicle, and the method described above for installing a fluid supply device of a transmission, have numerous advantages in relation to known devices and methods.

For example, using the fluid supply device, the costs of transmission manufacture can be reduced, for example in the casing production and/or in parts procurement, for example by the effects of scale.

Furthermore, in transmission manufacture, for example a complex installation of individual elements of the fluid supply device, for example the orifice, may be omitted since with the fluid supply device according to the invention, the elements are integrated in the fluid supply device housing.

Furthermore, the exchange of spare parts, for example in the case of a defective fluid supply device, can be achieved easily due to the modular structure.

Due to the fluid supply device, in addition more optimum use of space in transmissions may be achieved, for example in the transmission disclosed herein.

Integration of the orifice plate and/or the orifice function in the fluid supply device housing may for example reduce a complexity of the transmission. This may for example lead to easier installation of the transmission and/or to an increase in the precision of mounting of the shafts and/or rotational axes, for example of the pump.

Preferably, the orifice may be arranged directly in the fluid supply device, for example in an actuator, so that the orifice plate as an additional component is not required and no additional hydraulic lines in the transmission are required.

If the orifice function is integrated in the fluid supply device housing, additional bores in the transmission casing may be superfluous. Furthermore, a leakage oil flow may circulate around the electric motor and hence cool this. Furthermore, a filter outside the fluid supply device, in particular a suction filter and/or a pressure filter, may be omitted. For example, due to the internal leakage of the pump, an orifice may be superfluous and hence no clogging of this orifice and/or the filter outside the fluid supply device now occurs. Furthermore, exchange of the orifice plate and/or filter is simpler, for example by extraction of the fluid supply device according to the invention which is easily accessible and/or removable.

The fluid supply device may be used in numerous transmissions, for example in the transmission disclosed herein.

The features mentioned above and to be explained below may be used not only in the combination given, but also in other combinations or alone without leaving the scope of the present invention.

### BRIEF DESCRIPTION OF THE SEVERAL VIEWS OF THE DRAWING

Embodiments of the invention are shown as examples in the figures and explained in more detail in the description of the figures. The drawings show:

FIG. 1 a cross-sectional depiction of a first exemplary embodiment of a fluid supply device;

FIG. 2 a partial depiction of a first exemplary embodiment of a gerotor pump of a fluid supply device and/or of a transmission;

FIG. 3 a partial depiction of a second exemplary embodiment of a gerotor pump of a fluid supply device and/or of a transmission;

FIG. 4 a partial depiction of a third exemplary embodiment of a gerotor pump of a fluid supply device and/or of a transmission;

FIG. 5 a diagrammatic partial depiction of a first exemplary embodiment of a transmission;

FIG. 6 a diagrammatic partial depiction of a second exemplary embodiment of a transmission;

FIG. 7 a diagrammatic partial depiction of a third exemplary embodiment of a transmission;

FIG. 8 a diagrammatic partial depiction of a fourth exemplary embodiment of a transmission;

FIG. 9 a partial depiction of a fifth exemplary embodiment of a transmission;

FIG. 10 a cross-sectional depiction of a first exemplary embodiment of a fluid interface of a fluid supply device and/or of a transmission;

FIG. 11 a cross-sectional depiction of a second exemplary embodiment of a fluid interface of a fluid supply device and/or of a transmission;

FIG. 12 a cross-sectional depiction of a third exemplary embodiment of a fluid interface of a fluid supply device and/or of a transmission;

FIG. 13A a diagrammatic depiction of a second exemplary embodiment of a fluid supply device;

FIG. 13B a diagrammatic depiction of a third exemplary embodiment of a fluid supply device;

FIG. 14A a diagrammatic depiction of a fourth exemplary embodiment of a fluid supply device;

FIG. 14B a diagrammatic depiction of a fifth exemplary embodiment of a fluid supply device;

FIG. 15A a diagrammatic depiction of a sixth exemplary embodiment of a fluid supply device;

FIG. 15B a diagrammatic depiction of a seventh exemplary embodiment of a fluid supply device;

FIG. 16A a diagrammatic depiction of an eighth exemplary embodiment of a fluid supply device;

FIG. 16B a diagrammatic depiction of a ninth exemplary embodiment of a fluid supply device;

FIG. 17A a diagrammatic depiction of a tenth exemplary embodiment of a fluid supply device;

FIG. 17B a diagrammatic depiction of an eleventh exemplary embodiment of a fluid supply device;

FIG. 18A a diagrammatic depiction of a twelfth exemplary embodiment of a fluid supply device;

FIG. 18B a diagrammatic depiction of a thirteenth exemplary embodiment of a fluid supply device;

FIG. 19A a diagrammatic depiction of a fourteenth exemplary embodiment of a fluid supply device;

FIG. 19B a diagrammatic depiction of a fifteenth exemplary embodiment of a fluid supply device;

FIG. 20A a diagrammatic depiction of a sixteenth exemplary embodiment of a fluid supply device;

FIG. 20B a diagrammatic depiction of a seventeenth exemplary embodiment of a fluid supply device;

FIG. 21A a diagrammatic depiction of an eighteenth exemplary embodiment of a fluid supply device;

FIG. 21B a diagrammatic depiction of a nineteenth exemplary embodiment of a fluid supply device;

FIG. 22 a diagrammatic depiction of a twentieth exemplary embodiment of a fluid supply device.

### EMBODIMENTS

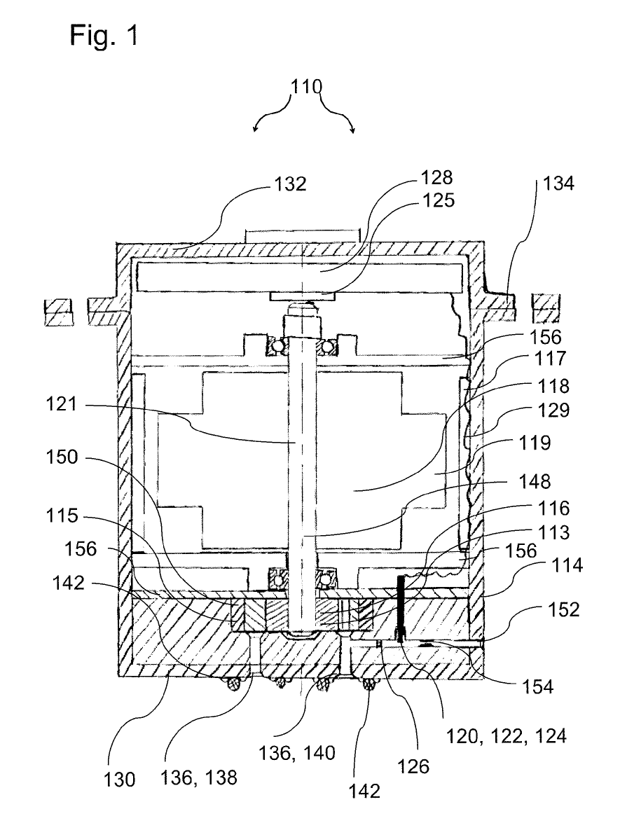

FIG. 1 shows a first exemplary embodiment of a fluid supply device 110 for a transmission 112 of a motor vehicle.

The fluid supply device 110 for a transmission 112 of a motor vehicle has a fluid supply device housing 114. At least one pump 116 and at least one electric motor 118 are integrated in the fluid supply device housing 114. The fluid supply device 110 is configured in modular fashion.

The electric motor 118 may have for example at least one stator 117 and/or at least one rotor 119 and/or at least one electric motor shaft 121.

At least one sensor 120, in particular at least one pressure sensor 122 and/or at least one temperature sensor 124, may be integrated in the fluid supply device housing 114. The sensor 120 may for example be combined pressure-temperature sensor.

The sensor 120 may for example be an incremental sensor 125. The incremental sensor 125 may for example be configured to detect a rotational frequency of the electric motor 118 and/or of the pump 116.

At least one filter 126 may be integrated in the fluid supply device housing 114.

At least one electrical unit 128, for example a control unit, may be integrated in the fluid supply device housing 114.

The fluid supply device 110 may have at least one cable passage 129. The cable passage 129 may for example be integrated in the fluid supply device housing 114. The cable passage 129 may for example connect at least one sensor 120 and/or the electric motor 118 to the electrical unit 128.

The fluid supply device housing 114 may have at least one housing pot 130 and at least one housing cover 132. The housing cover 132 may for example be connected, preferably permanently connected, to the housing pot 130. For example, the housing cover 132 may be welded and/or caulked to the housing pot 130. For example, the housing cover 132 may be connected to the housing pot 130 by means of at least one closing device 134. Alternatively, the housing cover 132 may be connected reversibly to the housing pot 130, in particular by means of at least one closing device 134.

The fluid supply device 110 may comprise at least one fluid interface 136. The fluid interface 136 may have at least one suction port 138, for example on a suction side, and at least one pressure port 140, for example on a pressure side. The fluid interface 136 may comprise at least one O-ring 142 for sealing the fluid interface 136.

The fluid interface 136 may have at least one, preferably two connecting pieces 144.

The fluid interface 136 may comprise at least one, preferably two connecting tubes 146.

The suction port 138 and/or the pressure port 140 may be oriented substantially parallel to a rotation axis 148 of the pump 116, or substantially perpendicular to the rotation axis 148 of the pump 116.

The fluid supply device 110 may comprise at least one internal leakage 150 and/or at least one external leakage 152. The internal leakage 150 may have a closed fluid circuit inside the fluid supply device housing 114 and/or inside the pump 116.

The internal leakage 150 and/or the external leakage 152 may comprise at least one orifice 154 and/or at least one filter 126 and/or at least one sensor 120, in particular at least one pressure sensor 122 and/or at least one temperature sensor 124.

The fluid supply device housing 114 may for example have at least one intermediate floor 156. Preferably, the fluid supply device housing 114 may have at least two intermediate floors 156 or three intermediate floors 156. The intermediate floor 156 may be configured for fixing the electric motor 118 and/or the pump 116. The intermediate floor 156 may have at least one opening, preferably a central opening, for passage of the electric motor shaft 121.

The electrical unit 128, the incremental sensor 125, the electric motor 118, the pump 116, the pressure sensor 122 and/or the temperature sensor 124, the filter 126, the orifice 154, the suction port 138 and the pressure port 140 may be arranged inside the fluid supply device housing 114, preferably in said order, from the housing cover 132 along the rotation axis 148 of the pump 116, as shown for example in FIG. 1.

FIG. 1 and FIGS. 13A to 22 show in particular exemplary embodiments of the fluid supply device 110, in which the suction port 138 and/or the pressure port 140 may be arranged for example axially, in particular substantially parallel to the rotation axis 148 of the pump 116, for example on the floor of the housing pot 130 and/or on the floor of the housing cover 132, preferably on the floor of the pump housing part 182.

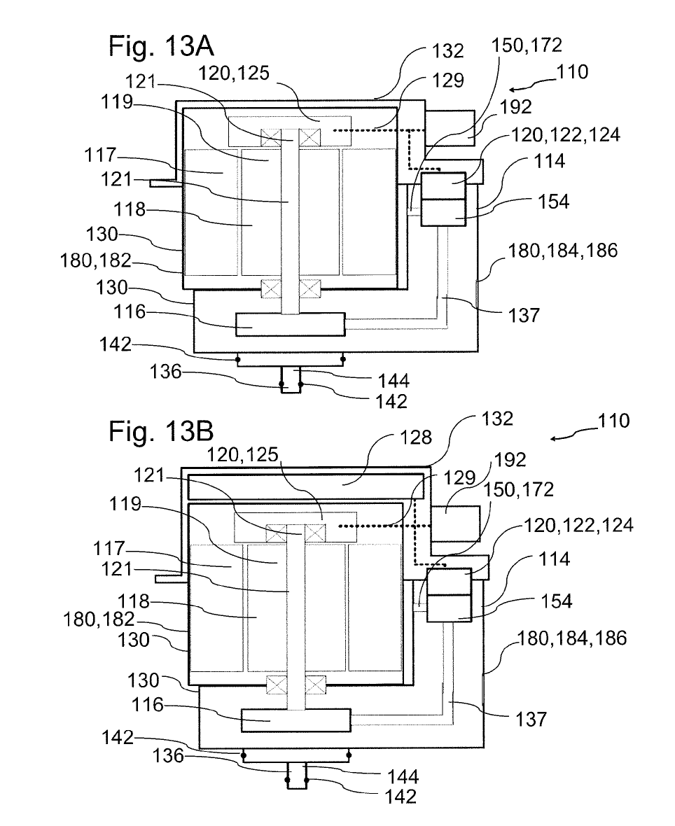

FIGS. 13A to 22 show further exemplary embodiments of fluid supply devices 110 for a transmission 112 of a motor vehicle.

FIG. 13A to 22 are diagrammatic depictions of exemplary embodiments of fluid supply devices 110. The exemplary embodiments in FIGS. 13A to 22 may in particular have elements which are not shown in the figures. For example, the exemplary embodiments in FIGS. 13A to 22 may have lines, in particular fluid lines and/or electrical lines, and/or filters and/or leakages and/or orifices and/or leakages and/or sensors and/or housing parts which are not explicitly shown in the figures.

The fluid supply device 110 for a transmission 112 of a motor vehicle according to FIGS. 13A to 22 has a fluid supply device housing 114. At least one pump 116 and at least one electric motor 118 are integrated in the fluid supply device housing 114. The fluid supply device 110 is configured in modular fashion.

The electric motor 118 may for example have at least one stator 117 and/or at least one rotor 119 and/or at least one electric motor shaft 121.

At least one sensor 120, in particular at least one pressure sensor 122 and/or at least one temperature sensor 124, may be integrated in the fluid supply device housing 114. The sensor 120 may for example be a combined pressure-temperature sensor.

The sensor 120 may for example be an incremental sensor 125. The incremental sensor 125 may for example be configured to detect a rotational frequency of the electric motor 118 and/or of the pump 116.

At least one filter 126 may be integrated in the fluid supply device housing 114.

At least one electrical unit 128, for example a control unit, may be integrated in the fluid supply device housing 114

The electrical unit 128 may preferably be a power electronics unit.

The fluid supply device 110 may have at least one cable passage 129. The cable passage 129 may for example be integrated in the fluid supply device housing 114. The cable passage 129 may for example connect the at least one sensor 120 and/or the electric motor 118 to the electrical unit 128. The cable passage 129 may have at least one cable.

The fluid supply device housing 114 may have at least one housing pot 130 and at least one housing cover 132. The fluid supply device housing 114 may for example have at least two housing pots 130 as housing parts 180. The housing pots may for example be nested together. The housing cover 132 may for example be connected, preferably permanently connected, to the housing pot 130. For example, the housing cover 132 may be welded and/or caulked to the housing pot 130. For example, the housing cover 132 may be connected to the housing pot 130 by means of a closing device 134. Alternatively, the housing cover 132 may be connected reversibly to the housing pot 130, in particular by means of at least one closing device 134.

In the fluid supply devices 110 according to the exemplary embodiments in FIGS. 13A to 22, the fluid supply device housing 114 may comprise at least two housing parts 180 connected together.

In particular, the fluid supply device housing 114 may have one housing part 180 comprising the electric motor 118, for example at least one electric motor housing part 182, and at least one housing part 180 comprising the pump 116, for example at least one pump housing part 184.

In the exemplary embodiments of the fluid supply devices 110 shown in FIGS. 13A to 22, the fluid supply device housing 114 may have precisely one electric motor housing part 182 and precisely one pump housing part 184.

In particular in the exemplary embodiments of the fluid supply devices 110 shown in FIGS. 13A, 13B and 15A to 22, the fluid supply device housing 114 may have at least one line housing part 186.

In particular in the exemplary embodiments of the fluid supply devices 110 shown in FIGS. 13A, 13B, 17A to 18B, and 21A to 22, the line housing part 186 may have at least one fluid line 137.

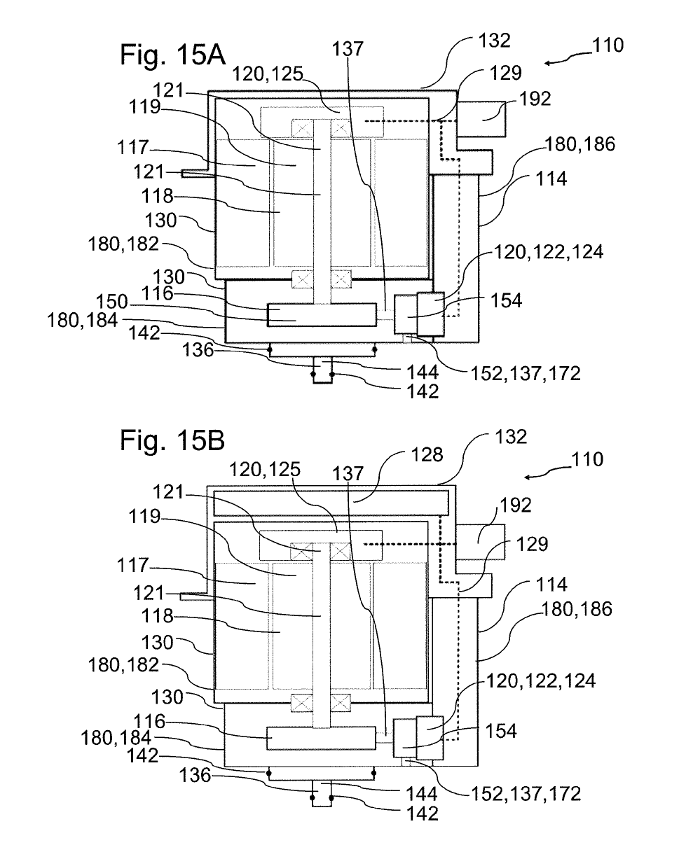

In particular in the exemplary embodiments of the fluid supply devices 110 shown in FIGS. 15A to 16B, and 19A to 20B, the line housing part 186 may have at least one electrical line.

In particular in the exemplary embodiments of the fluid supply devices 110 shown in FIGS. 13A, 13B, 17A to 18B, and 21A to 22, the line housing part 186 and the pump housing part 184 may be configured as one housing part 180.

Alternatively or additionally, the fluid supply device housing 114 of the exemplary embodiments of the fluid supply devices 110 shown in FIGS. 13A to 22 may have at least one housing part 180 comprising at least one orifice 154 and/or at least one valve 190, for example at least one valve housing part 188.

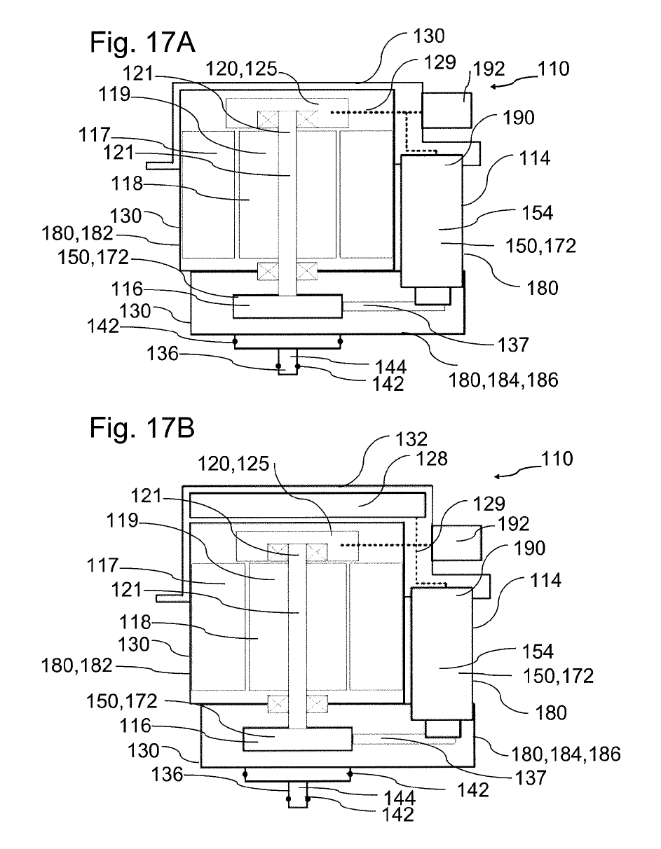

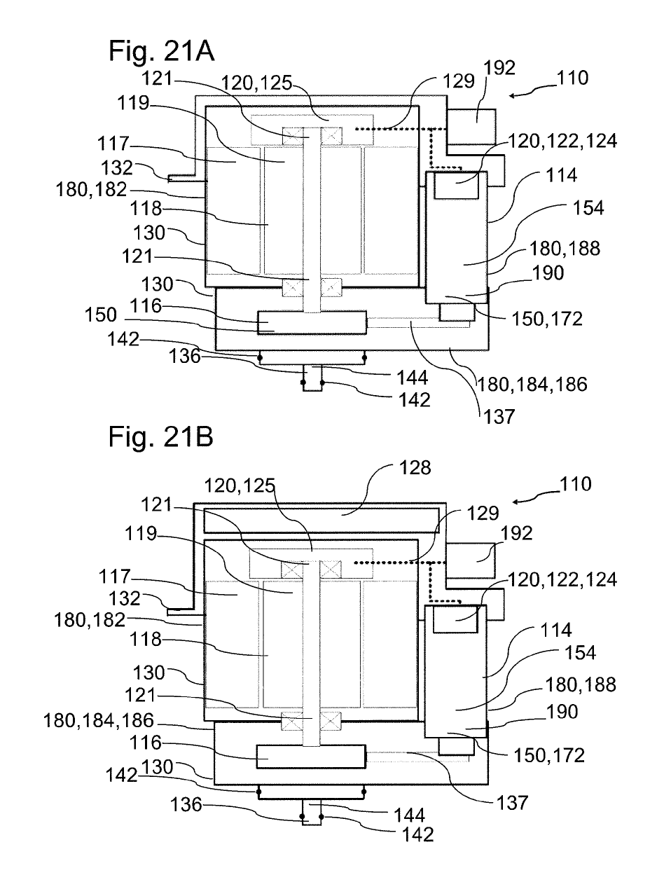

The valve housing part 188 may form at least partially an outer wall of the fluid supply device housing 114, such as for example in the exemplary embodiments of FIGS. 17A, 17B, 21A and 21B.

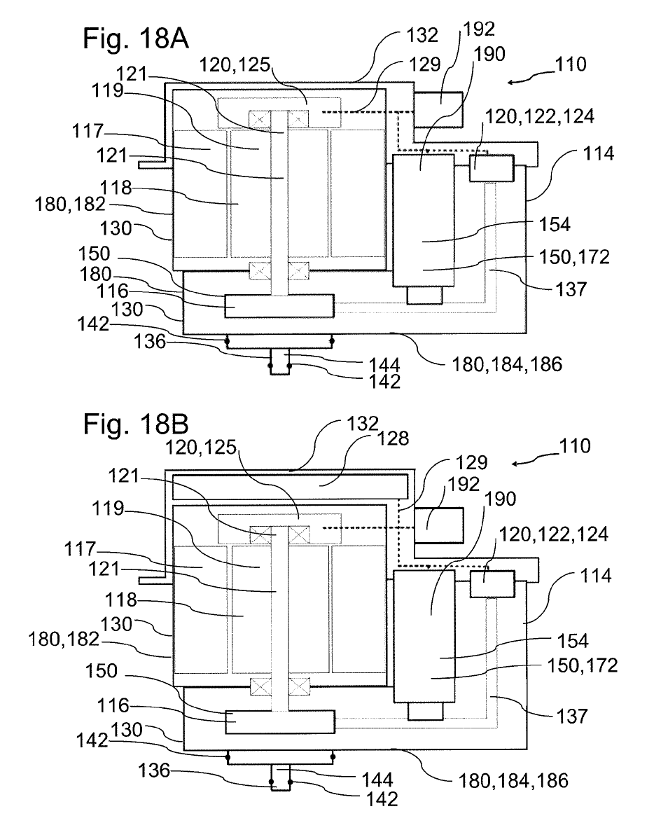

In principle, the valve housing part 188 may also be completely integrated in the fluid supply device housing 114, such as for example in the exemplary embodiments of FIGS. 18A to 20B and 22.

The exemplary embodiments of the fluid supply devices 110 shown in FIGS. 13A to 22 may in particular have at least one plug connector 192. The plug connector 192 may be configured to supply at least part of the fluid supply device 110 with electrical energy and/or with at least one control signal. Alternatively or additionally, the plug connector 192 may be configured to pick up at least one signal, for example a measurement signal. The plug connector 192 may for example be configured as an electrical interface.

Preferably, the exemplary embodiments of the fluid supply devices 110 shown in FIGS. 1 and 13A to 22 may have precisely one plug connector 192.

The plug connector 192 may preferably be arranged laterally on the fluid supply device housing 114. Particularly preferably, the plug connector 192 may be arranged on a shell of the housing pot 130.

The fluid supply device 110 may comprise at least one fluid interface 136. The fluid interface 136 may have at least one suction port 138, for example on a suction side, and at least one pressure port 140, for example on a pressure side. The fluid interface 136 may comprise at least one O-ring 142 for sealing the fluid interface 136.

The fluid interfaces 136 shown in the exemplary embodiments in FIGS. 13A to 22 may preferably comprise two O-rings 142 for sealing the fluid interface 136. The two O-rings 142 may preferably have different diameters.

The fluid interface 136 may have at least one connecting piece 144, preferably two connecting pieces 144. For example, the connecting piece 144 may taper towards the end remote from the fluid supply device housing 114. The connecting piece 144 may for example have two pipes with different diameters. The connecting piece 144 may have a smaller diameter at the end remote from the fluid supply device housing 114 than at the outlet of the connecting piece 144 from the fluid supply device housing 114.

The O-ring 142 located at the end of the connecting piece 144 may preferably have a smaller diameter than the O-ring 142 at the outlet of the connecting piece 144 from the fluid supply device housing 114.

The fluid interface 136 may comprise at least one, preferably two connecting tubes 146.

The suction port 138 and/or the pressure port 140 may preferably be oriented substantially parallel to a rotation axis 148 of the pump 116.

The fluid supply device 110 may comprise at least one internal leakage 150 and/or at least one external leakage 152. The internal leakage 150 may have a closed fluid circuit inside the fluid supply device housing 114 and/or inside the pump 116.

The internal leakage 150 and/or the external leakage 152 may comprise at least one orifice 154 and/or at least one valve 190 and/or at least one filter 126 and/or at least one sensor 120, in particular at least one pressure sensor 122 and/or at least one temperature sensor 124.

The fluid supply device housing 114 may for example have at least one intermediate floor 156. Preferably, the fluid supply device housing 114 may have at least two intermediate floors 156 or three intermediate floors 156. The intermediate floor 156 may be configured for fixing the electric motor 118 and/or the pump 116. The intermediate floor 156 may have at least one opening, preferably a central opening, for passage of the electric motor shaft 121.

The exemplary embodiment in FIG. 13A differs from the exemplary embodiment in FIG. 13B in particular in that at least one electrical unit 128, for example a control unit, may be integrated in the fluid supply device housing 114 of the exemplary embodiment in FIG. 13B. Particularly preferably, a power electronics unit may be integrated in the fluid supply device housing 114 of the exemplary embodiment in FIG. 13B.

In the exemplary embodiments of the fluid supply devices 110 shown in FIGS. 13A and 13B, the fluid supply device housing 114 may in particular comprise at least one electric motor housing part 182 and at least one pump housing part 184. At least one fluid line 137 may be integrated in the fluid supply device housing 114.

The pump 116 and/or the at least one fluid line 137 and/or the at least one temperature sensor 124 and/or the at least one pressure sensor 122, preferably a combined temperature-pressure sensor, and/or the at least one orifice 154 may be integrated in the pump housing part 184.

The fluid interface 136 may preferably be arranged on the pump housing part 184. The pump housing part 184 may preferably have the form of a cylinder with a lateral arm. In particular, the temperature sensor 124 and/or the pressure sensor 122 and/or the orifice 154 and/or at least partially the fluid lines 137 may be integrated in the arm.

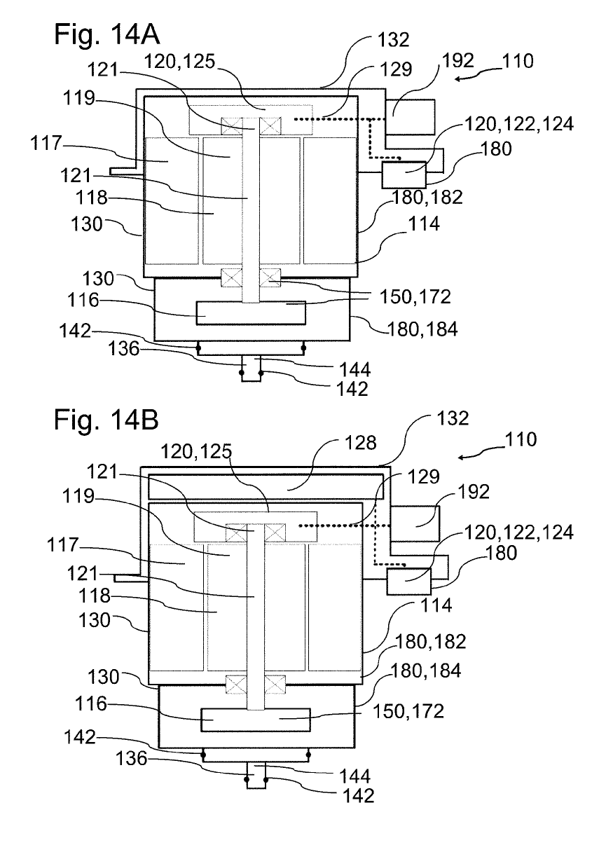

The exemplary embodiment in FIG. 14A differs from the exemplary embodiment in FIG. 14B in particular in that at least one electrical unit 128, for example a control unit, may be integrated in the fluid supply device housing 114 of the exemplary embodiment in FIG. 14B. Particularly preferably, a power electronics unit may be integrated in the fluid supply device housing 114 of the exemplary embodiment in FIG. 14B.

In the exemplary embodiments of the fluid supply devices 110 shown in FIGS. 14A and 14B, the fluid supply device housing 114 may in particular comprise at least one electric motor housing part 182 and at least one pump housing part 184.

The pump 116 may preferably be integrated in the pump housing part 184.

Preferably, the electric motor 118 and/or at least one sensor 120, preferably the incremental sensor 125, may be integrated in the electric motor housing part 182.

The pump housing part 184 and the electric motor housing part may preferably be configured substantially rotationally symmetrically to the rotation axis 148 of the pump 116. However, for example the housing cover 132 may be non-rotationally symmetrical at least at one radial side, but have a lateral cable passage 129. Furthermore, for example at least one plug connector 192 and/or at least one sensor 120, for example at least one temperature sensor 124 and/or at least one pressure sensor 122, preferably a combined temperature-pressure sensor, may be arranged laterally on the fluid supply device housing 114, e.g. on the housing cover 132. The plug connector 192 and/or the temperature sensor 124 and/or the pressure sensor 122, preferably the combined temperature-pressure sensor, may be integrated fully or partly in the housing cover 132. Preferably, the plug connector 192 may be arranged externally on the housing cover 132, and the temperature sensor 124 and/or the pressure sensor 122, preferably the combined temperature-pressure sensor, may be partially integrated in the housing cover 132 and be partially arranged outside the housing cover 132.

The incremental sensor 125 and the combined temperature-pressure sensor may in particular be connected to the plug connector 192 via at least one cable passage 129.

The exemplary embodiment in FIG. 15A differs from the exemplary embodiment in FIG. 15B in particular in that at least one electrical unit 128, for example a control unit, may be integrated in the fluid supply device housing 114 of the exemplary embodiment in FIG. 15B. Particularly preferably, a power electronics unit may be integrated in the fluid supply device housing 114 of the exemplary embodiment in FIG. 15B.

In the exemplary embodiments of the fluid supply devices 110 shown in FIGS. 15A and 15B, the fluid supply device housing 114 may in particular comprise at least one electric motor housing part 182 and at least one pump housing part 184 and at least one line housing part 186.

The at least one pump 116 and/or the at least one fluid line 137 and/or the at least one temperature sensor 124 and/or the at least one pressure sensor 122, preferably a combined temperature-pressure sensor, and/or the at least one orifice 154 may be at least partially integrated in the pump housing part 184.

The fluid interface 136 may preferably be arranged on the pump housing part 184. The pump housing part 184 may preferably have the form of a cylinder. The pump housing part 184 may preferably have a lateral opening. Preferably the sensor 120, in particular the combined temperature-pressure sensor 120, may be arranged in the lateral opening. The lateral opening of the pump housing part 184 may be connected to the housing cover 132 by means of the line housing part 186.

The combined temperature-pressure sensor may be arranged partially in the pump housing part 184 and partially in the line housing part 186.

The line housing part 186 may preferably have an electrical line between the sensor 120, in particular the combined temperature-pressure sensor, and the plug connector 192. The plug connector 192, like the combined temperature-pressure sensor, may preferably be arranged laterally to the rotation axis 148 of the pump 116.

In particular, an opening may be present between the electric motor housing part 182 and/or the line housing part 186 and/or the pump housing part 184 and/or the housing cover 132.

The fluid supply device 110 according to FIGS. 15A and 15B may in particular have an external leakage 152. The external leakage 152 may in particular comprise an outflow of fluid from the fluid supply device housing 114, in particular from the pump housing part 184. The fluid outflow may preferably be arranged in the axial direction.

Preferably, a connection of the electrical line to the sensor 120, in particular the combined temperature-pressure sensor, may be arranged parallel to the rotation axis 148, i.e. axially, in particular on the side facing away from the electric motor 118.

In particular, the temperature sensor 124 and/or the pressure sensor 122 and/or the orifice 154 and/or at least partially the fluid lines 137 may be integrated in the arm.

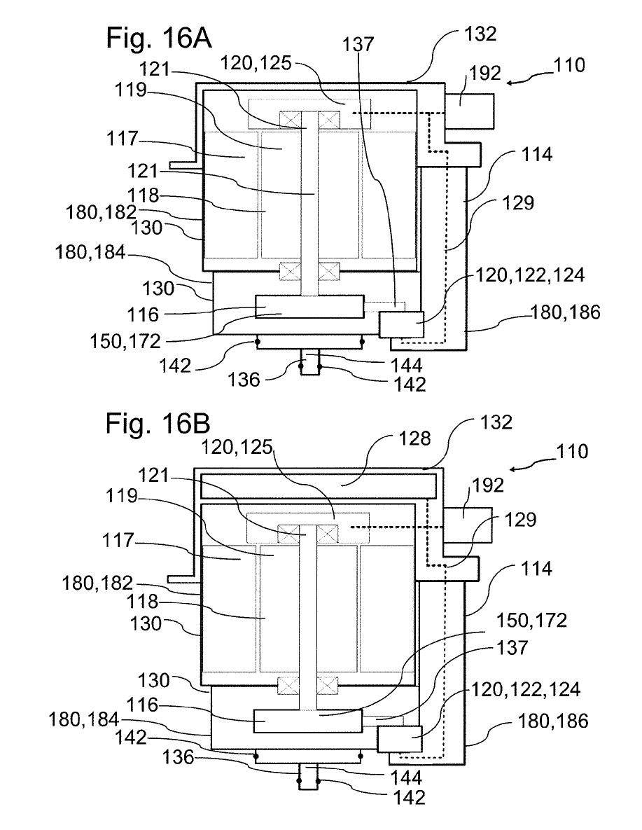

The exemplary embodiment in FIG. 16A differs from the exemplary embodiment in FIG. 16B in particular in that at least one electrical unit 128, for example a control unit, may be integrated in the fluid supply device housing 114 of the exemplary embodiment in FIG. 16B. Particularly preferably, a power electronics unit may be integrated in the fluid supply device housing 114 of the exemplary embodiment in FIG. 16B.

The exemplary embodiments of the fluid supply devices 110 shown in FIGS. 16A and 16B differ from the exemplary embodiment in FIGS. 16A and 16B in particular in that the exemplary embodiments of the fluid supply devices 110 according to the invention shown in FIGS. 16A and 16B have no external leakage 152 and no orifice 154, in particular in the pump housing part.

The line housing part 186 may protrude in the axial direction over the pump housing part 184. A connection of the electrical line to the sensor 120, in particular the combined temperature-pressure sensor, may preferably be arranged parallel to the rotation axis 148, i.e. axially, in particular on the side facing away from the electric motor 118.

The exemplary embodiment in FIG. 17A differs from the exemplary embodiment in FIG. 17B in particular in that at least one electrical unit 128, for example a control unit, may be integrated in the fluid supply device housing 114 of the exemplary embodiment in FIG. 17B. Particularly preferably, a power electronics unit may be integrated in the fluid supply device housing 114 of the exemplary embodiment in FIG. 17B.

The exemplary embodiments shown in FIGS. 17A and 17B preferably have no pressure sensor 122 and/or no temperature sensor 124. In principle however, these exemplary embodiments too could have at least one pressure sensor 122 and/or at least one temperature sensor 124.

In the exemplary embodiments of the fluid supply devices 110 shown in FIGS. 17A and 17B, the fluid supply device housing 114 may comprise in particular at least one electric motor housing part 182 and at least one pump housing part 184 and at least one valve housing part 188.

The at least one pump 116 and/or the at least one fluid line 137 may be integrated in the pump housing part 184.

Preferably, the fluid interface may be arranged on the pump housing part 184, in particular on an axial end facing away from the electric motor 118. The pump housing part 184 may preferably take the form of a cylinder with a bulge on one side. The pump housing part 184 may preferably have an axial opening at the bulge. Preferably, the valve 190 and/or the sensor 120, in particular the combined temperature-pressure sensor, may be arranged in the axial opening. The pump housing part 184 may be connected to the housing cover 132 via the valve housing part 188.

The combined temperature-pressure sensor and/or the valve 190 may be arranged partially in the pump housing part 184 and partially in the valve housing part 188.

The housing cover 132 may preferably have an electrical line between the valve 190 and/or a sensor 120, in particular the combined temperature-pressure sensor, and the plug connector 192. The plug connector 192, like the valve 190 and/or the combined temperature pressure sensor, may preferably be arranged laterally to the rotation axis 148 of the pump 116.

For example, the fluid supply device 110 may be configured without a temperature sensor 124 and/or without a pressure sensor 122 and/or without a combined temperature-pressure sensor.

In particular, an opening may be present between the electric motor housing part 182 and/or the valve housing part 188 and/or the pump housing part 184 and/or the housing cover 132.

The fluid supply device 110 according to FIGS. 17A and 17B may in particular have an internal leakage 150. The internal leakage 150 may in particular comprise the valve 190, in particular as a controllable internal leakage 150, and/or an orifice 154.

The exemplary embodiment in FIG. 18A differs from the exemplary embodiment in FIG. 18B in particular in that at least one electrical unit 128, for example a control unit, may be integrated in the fluid supply device housing 114 of the exemplary embodiment in FIG. 18B. Particularly preferably, a power electronics unit may be integrated in the fluid supply device housing 114 of the exemplary embodiment in FIG. 18B.

In the exemplary embodiments of the fluid supply devices 110 shown in FIGS. 18A and 18B, the fluid supply device housing 114 may comprise in particular at least one electric motor housing part 182 and at least one pump housing part 184 and at least one valve housing part 188.

At least one fluid line 137 may be integrated in the fluid supply device housing 114, preferably in the pump housing part 184.

The valve housing part 188 may be integrated at least partially in the housing cover 132 and/or in the pump housing part 184.

The pump 116 and/or the at least one fluid line 137 may be integrated in the pump housing part 184.

Preferably, the fluid interface 136 may be arranged on the pump housing part 184. The pump housing part 184 may preferably have the form of a cylinder with a lateral arm. In particular, the temperature sensor 124 and/or the pressure sensor 122, preferably the combined temperature-pressure sensor, and/or the valve 190, may be at least partially integrated in the arm.

The valve 190 may for example be configured to perform the function of a controllable orifice 154 of an internal leakage 150.

The exemplary embodiments of the fluid supply devices 110 shown in FIGS. 18A and 18B may in principle be configured as those of the exemplary embodiments in FIGS. 13A and 13B, wherein the orifice 154 of FIGS. 18A and 18B may be replaced by the valve 190 as an adjustable orifice 154.

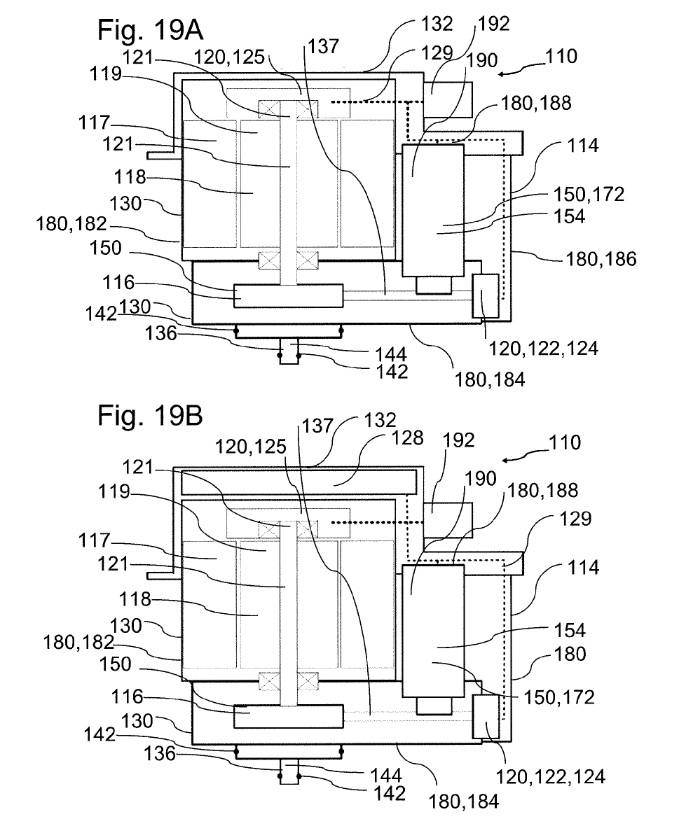

The exemplary embodiment in FIG. 19A differs from the exemplary embodiment in FIG. 19B in particular in that at least one electrical unit 128, for example a control unit, may be integrated in the fluid supply device housing 114 of the exemplary embodiment in FIG. 19B. Particularly preferably, a power electronics unit may be integrated in the fluid supply device housing 114 of the exemplary embodiment in FIG. 19B.

The exemplary embodiments according to FIGS. 19A and 19B may be configured as the exemplary embodiments in FIGS. 18A and 18B, wherein the fluid supply device housing 114 may additionally have a line housing part 186. The sensor 120, in particular the combined temperature-pressure sensor, may preferably not be arranged partially in the housing cover 132 and partially in the pump housing part 184, as in FIGS. 18A and 18B, but be partially integrated in the line housing part 186 and partially in the pump housing part 184.

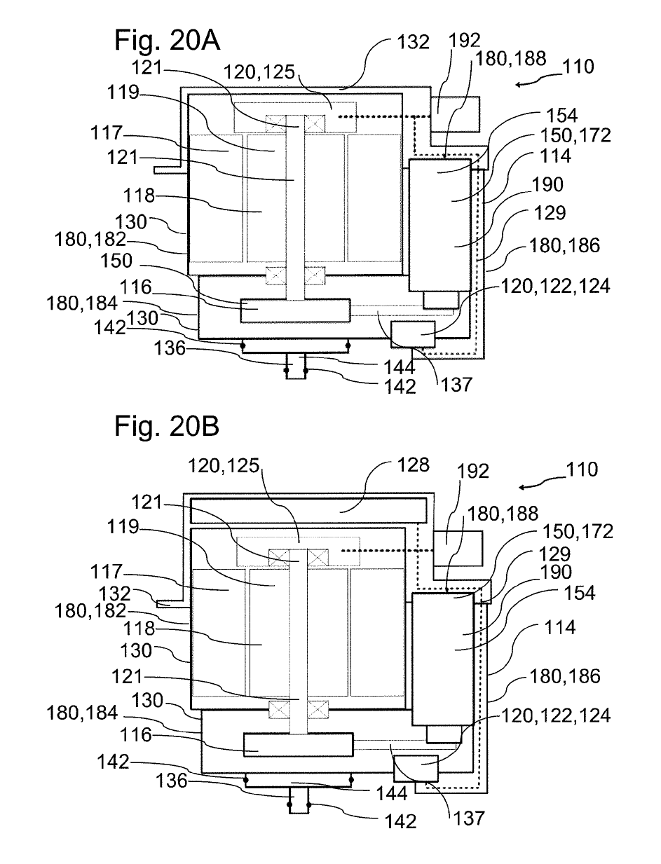

The exemplary embodiment in FIG. 20A differs from the exemplary embodiment in FIG. 20B in particular in that at least one electrical unit 128, for example a control unit, may be integrated in the fluid supply device housing 114 of the exemplary embodiment in FIG. 20B. Particularly preferably, a power electronics unit may be integrated in the fluid supply device housing 114 of the exemplary embodiment in FIG. 20B.

The exemplary embodiments in FIGS. 20A and 20B may differ from the exemplary embodiments in FIG. 19A or 20A in particular in that the sensor 120, in particular the temperature sensor 124 and/or the pressure sensor 122, preferably the combined temperature-pressure sensor, is arranged such that the connection of the sensor 120, in particular of the temperature sensor 124 and/or of the pressure sensor 122, preferably of the combined temperature-pressure sensor, to the electrical line is arranged not radially but axially, and/or the sensor 120, in particular the temperature sensor 124 and/or the pressure sensor 122, preferably the combined temperature-pressure sensor, may have no direct connection to the fluid line 137.

The exemplary embodiment in FIG. 21A differs from the exemplary embodiment in FIG. 21B in particular in that at least one electrical unit 128, for example a control unit, may be integrated in the fluid supply device housing 114 of the exemplary embodiment in FIG. 21B. Particularly preferably, a power electronics unit may be integrated in the fluid supply device housing 114 of the exemplary embodiment in FIG. 21B.

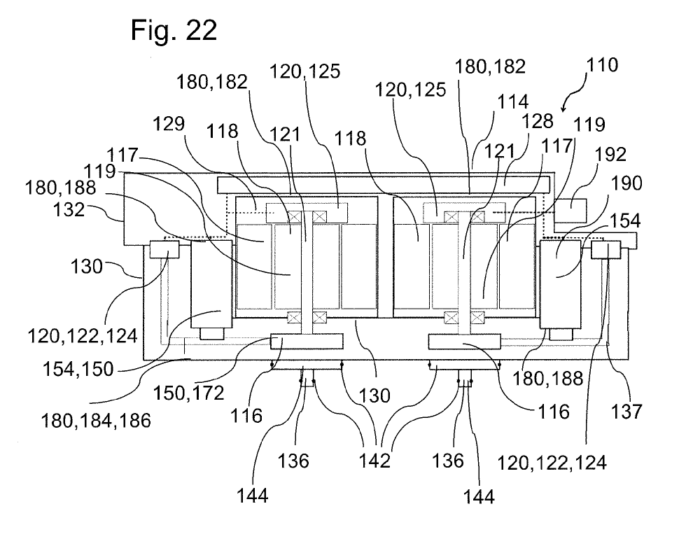

The exemplary embodiments of FIGS. 21A and 21B may in principle be configured like the exemplary embodiments in FIGS. 17A and 17B, wherein the exemplary embodiment in FIGS. 21A and 21B may additionally, preferably, have at least one temperature sensor 124 and/or at least one pressure sensor 122, preferably at least one combined temperature-pressure sensor, wherein this sensor 120 may preferably be integrated at least partially in the valve housing. In the exemplary embodiment of a fluid supply device 110 according to the invention shown in FIG. 22, the pump housing part 184 and/or the line housing part 186 may preferably have two pumps 116 and/or two fluid lines 137.

In the exemplary embodiment of a fluid supply device 110 according to the example shown in FIG. 22, the fluid supply device housing 114 may have precisely two electric motor housing parts 182 and precisely one pump housing part 184 and precisely two valve housings.

The exemplary embodiment in FIG. 22 may in particular have two valve housing parts 188.

At least two pumps 116 and at least two electric motors 118 may be integrated in the fluid supply device housing 114 of the exemplary embodiment shown in FIG. 22. Preferably, precisely two pumps 116 and precisely two electric motors 118 may be integrated in the fluid supply device housing 114 of the exemplary embodiment shown in FIG. 22.

Preferably, precisely one electrical unit 128, for example precisely one control unit, may be integrated in the fluid supply device housing 114 of the exemplary embodiment in FIG. 22. The control unit may be configured to actuate all pumps 116 and/or all electric motors 118, preferably two pumps 116 and/or two electric motors 118. The control unit may furthermore be configured to actuate all valves 190, preferably two valves 190. The electrical unit 128 may preferably be a power electronics unit.

The fluid supply device 110 according to the exemplary embodiment in FIG. 22 may preferably have two fluid interfaces 136.

In the exemplary embodiment of a fluid supply device 110 shown in FIG. 22, the two electric motors 118 and/or the two electric motor housing parts 182 and/or the two valves 190 and/or the two fluid interfaces 136 and/or the two sensors 120, preferably the two combined temperature-pressure sensors, and/or the two pumps 116, may be arranged symmetrically to a line parallel to the axis. An asymmetry of the fluid supply device 110 may preferably be created in that the fluid supply device 110 preferably has only one plug connection 192, which in particular may be arranged laterally on the housing cover 132.

In a further aspect, a transmission 112 for a motor vehicle is proposed. The transmission 112 comprises at least one fluid supply device 110 as described above. The transmission 112 comprises at least one fluid sump 162. The transmission 112 comprises at least one clutch 178. The fluid supply device 110 is configured to supply fluid from the fluid sump 162 to the clutch 178 in a controlled fashion.

The pump 116 may for example be a gerotor pump. The pump 116 may comprise at least one external rotor 115 and at least one internal rotor 113. The internal rotor 113 a for example be driven by the electric motor 118. The external rotor 115 may for example be driven by a rotation of the internal rotor 113. The pump 116 may furthermore comprise at least one suction nodule 123 and/or at least one pressure nodule 127. The suction nodule 123 and/or the pressure nodule 127 may preferably be arranged rotationally fixedly, for example relative to the fluid supply device housing 114. The suction nodule 123 and/or the pressure nodule 127 may be nodular pump cavities. The suction nodule 123 may for example be connected to the suction port 138. The pressure nodule 127 may for example be connected to the pressure port 140.

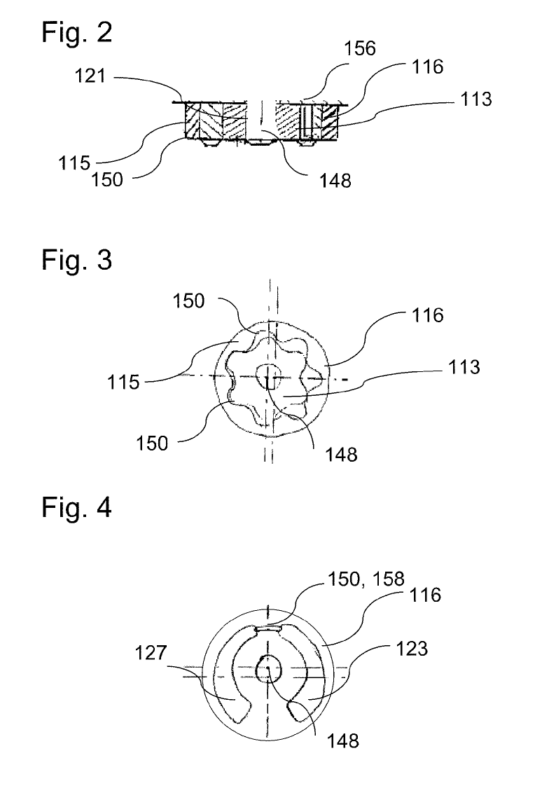

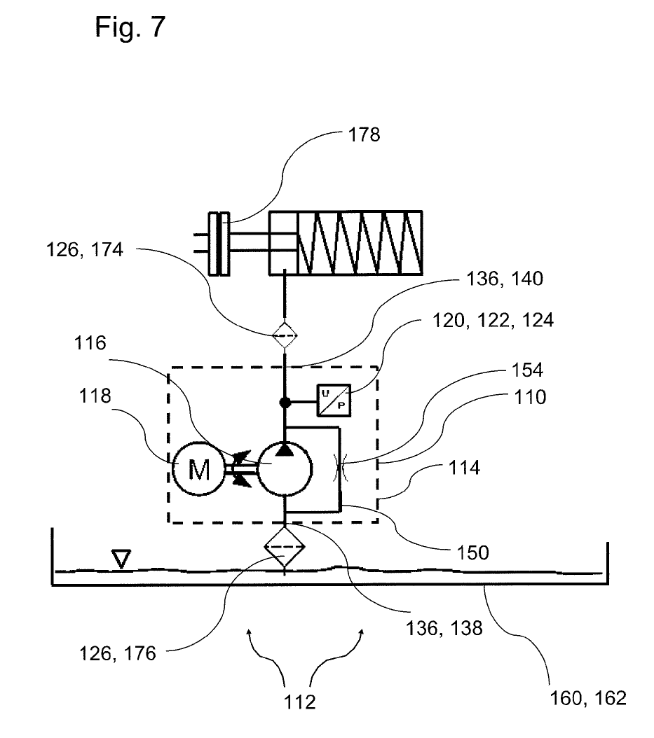

Preferably, the pump 116 may have at least the internal leakage 150. For example, the orifice 154 and/or an orifice function may be integrated in the pump 116. FIGS. 2, 3 and 4 show depictions of various pumps 116 of exemplary embodiments of the fluid supply device 110, and/or of the transmission 112. FIGS. 2, 3 and 4 show in particular various possibilities for integrating the internal leakage 150 and/or the orifice 154 and/or the orifice function in the pump 116. Here, an orifice function and/or the internal leakage 150 may be implemented by higher tolerances and/or greater spacing dimensions. For example, the pump 116 may have a greater axial play, as shown in FIG. 2, and/or a greater radial play and/or a greater head play, as shown in FIG. 3, and/or a connection 158 between the suction nodule 123 and the pressure nodule 127, as shown in FIGS. 4 and 7. The suction nodule 123 and/or the pressure nodule 127 may preferably have a narrow end and a wide end. The connection 158 between the suction nodule 123 and the pressure nodule 127 may preferably be arranged between the narrow end of the suction nodule 123 and the narrow end of the pressure nodule 127.

The suction nodule 123 and/or the pressure nodule 127 may in particular have at least one groove and/or at least one chamfer in the nodule geometry.

For example, the pump 116 may have an axial play and/or a radial play and/or a head play of 0.001 mm to 1 mm, preferably of 0.01 mm to 0.5 mm, particularly preferably of 0.02 mm to 0.1 mm.

Alternatively or additionally, an internal leakage 150 and/or an orifice function may be implemented by a lateral outflow and/or by a radial cooling outlet.

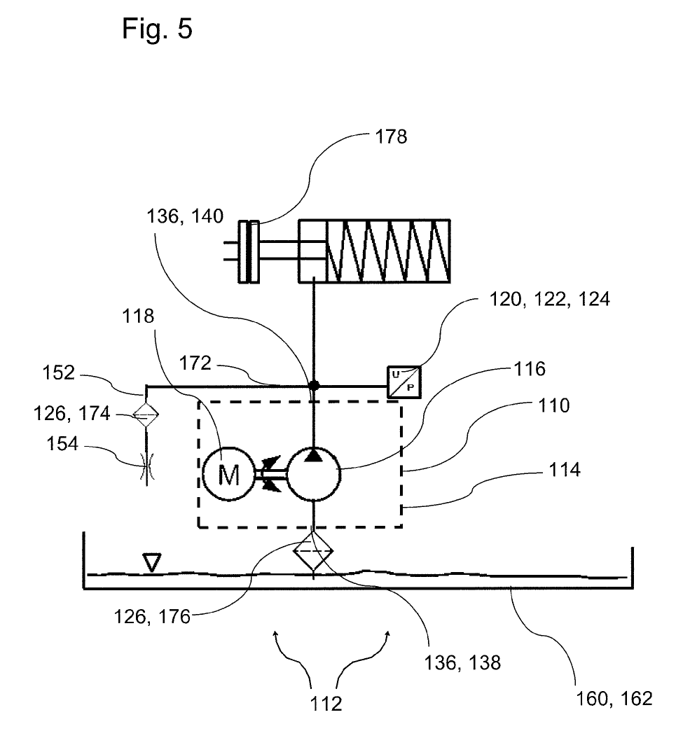

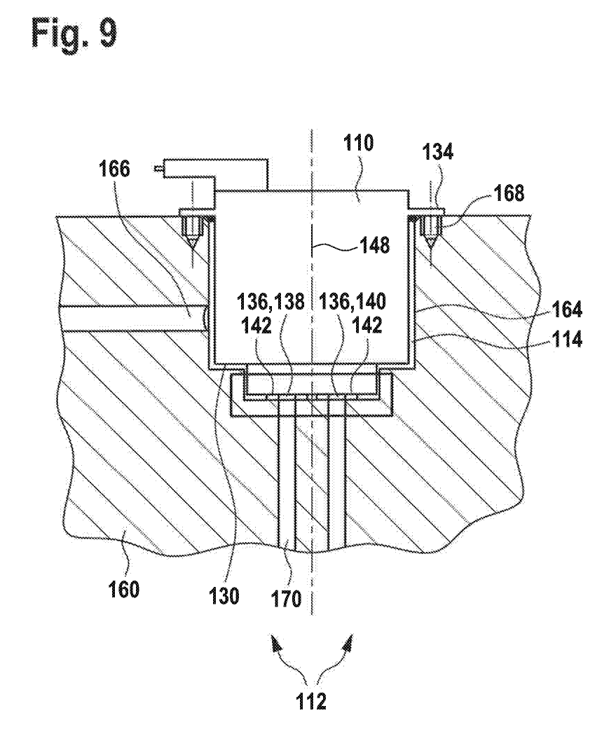

FIGS. 5 to 8 show diagrammatic partial depictions of exemplary embodiments of the transmission 112. In the context of the present invention, the schematic symbol for an orifice 154 may mean both an orifice plate 154 and an equivalent circuit for the orifice function, for example an internal leakage 150. The transmissions 112 may have at least one orifice plate 154 and/or at least one orifice function. FIGS. 9 to 12 show partial depictions of exemplary embodiments of the transmission 112 as cross-sectional drawings.

The transmission 112 may comprise at least one transmission casing 160. In FIGS. 5 to 8, the transmission 112 is depicted only partially diagrammatically, in particular with a fluid sump 162. The transmission casing 160 may be configured preferably separately from the fluid supply device housing 114.

The transmission casing 160 may comprise at least one recess 164, wherein the fluid supply device 110 may be received at least partially in the recess 164.

At least one O-ring 142, preferably two O-rings 142, may be arranged between the transmission casing 160 and the fluid supply device housing 114.

The transmission casing 160 may have a device 166 for cooling the electric motor 118.

The fluid supply device housing 114 may be fixed to the transmission casing 160 by means of at least one fixing device 168.

The transmission casing 160 may comprise at least one bore 170 for a pressure port 140 and/or at least one bore 170 for a suction port 138.

Outside the fluid supply device housing 114, the transmission 112 may comprise at least one sensor 120, in particular at least one pressure sensor 122 and/or at least one temperature sensor 124, and/or at least one filter 126 and/or at least one leakage 172.

The fluid supply device 110 and/or the transmission 112 may have at least one leakage 172, in particular at least one internal leakage 150 and/or at least one external leakage 152.

FIG. 5 shows part of an exemplary embodiment of a transmission 112, wherein the transmission 112 has a leakage 172. The leakage 172 may here be configured as a fluid line 137 by a line portion between the pump 116 and the clutch 178 to the fluid sump 162. The line portion may preferably be arranged outside the fluid supply device 110. The fluid line 137 may have at least one filter 126 and/or at least one orifice 154. The transmission 112 shown in FIG. 5 may in particular comprise a fluid supply device housing 114 in which an electric motor 118 and a pump 116 may be integrated.

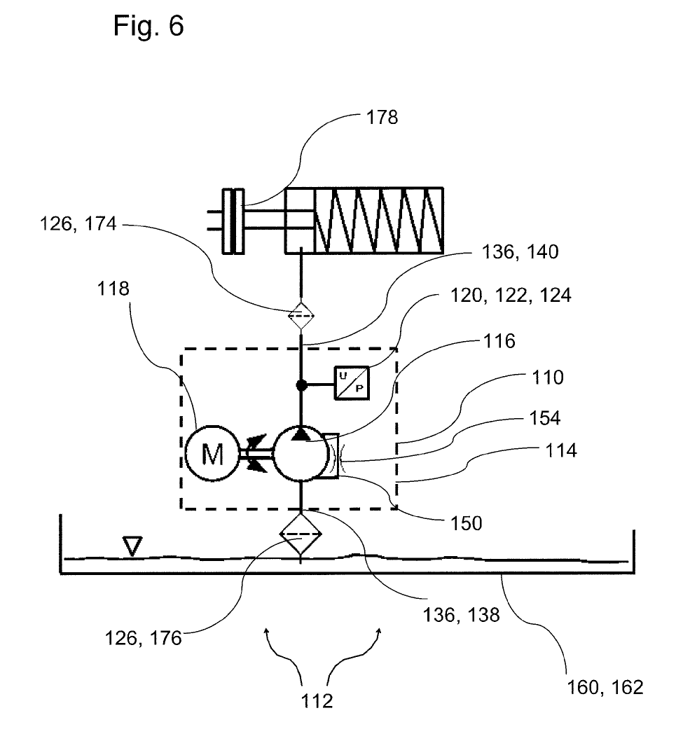

FIGS. 6 and 7 show exemplary embodiments of the fluid supply device 110 and/or the transmission 112 with an internal leakage 150, in particular inside the fluid supply device 110 and/or inside the fluid supply device housing 114.

FIG. 6 shows an internal leakage 150, wherein the leakage 172 may be integrated in the pump 116, for example by a fluidic short-circuit inside the pump 116. The transmission 112 shown in FIG. 6 may in particular comprise a fluid supply device housing 114 which integrates an electric motor 118 and a pump 116 and a sensor 120, in particular a pressure sensor 122, and an internal leakage 150 in the pump 116.

FIG. 7 shows an internal leakage 150, wherein the leakage 172 is integrated in the fluid supply device housing 114, for example by a fluidic short-circuit in the fluid supply device housing 114. The transmission 112 shown in FIG. 7 may in particular comprise a fluid supply device housing 114 which integrates an electric motor 118 and a pump 116 and a sensor 120, in particular a pressure sensor 122, and an internal leakage 150.

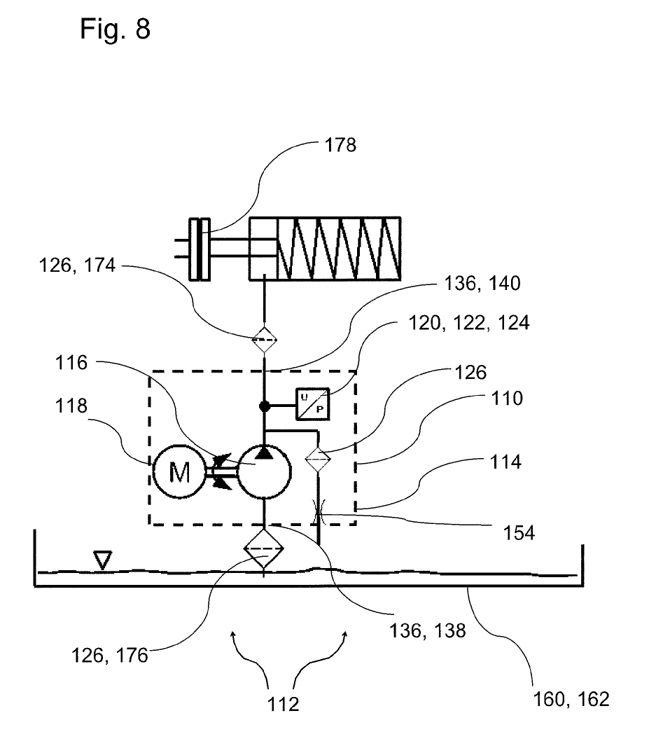

FIG. 8 shows an exemplary embodiment of the fluid supply device 110 and/or the transmission 112 with an external leakage 152. The external leakage 152 may in particular lead out of the fluid supply device housing 114. For example, a volume flow of fluid may be returned externally to the oil sump and/or used. The transmission 112 shown in FIG. 6 may in particular comprise a fluid supply device housing 114 which integrates an electric motor 118 and a pump 116 and a sensor 120, in particular a pressure sensor 122, and an external leakage 152, in particular an external leakage 152 with a filter 126 and an orifice 154.

The transmissions 112 shown in FIGS. 5 to 8 may in particular have at least two filters 126, preferably a high-pressure filter 174 and a suction filter 176, which may preferably be arranged inside the transmission casing 160 and outside the fluid supply device housing 114.

FIG. 9 shows as an example a partial depiction of a transmission 112, wherein the transmission 112 may have at least one device 166 for cooling, preferably a radial device 166 for cooling the electric motor 118, and at least one axial suction port 138 and at least one axial pressure port 140. The transmission 112 shown in FIG. 9 may in particular comprise a fluid supply device 110 with an electric motor 118 and a pump 116 and an orifice 154 and a pressure sensor 122 and a temperature sensor 124, preferably integrated in the fluid supply device housing 114.

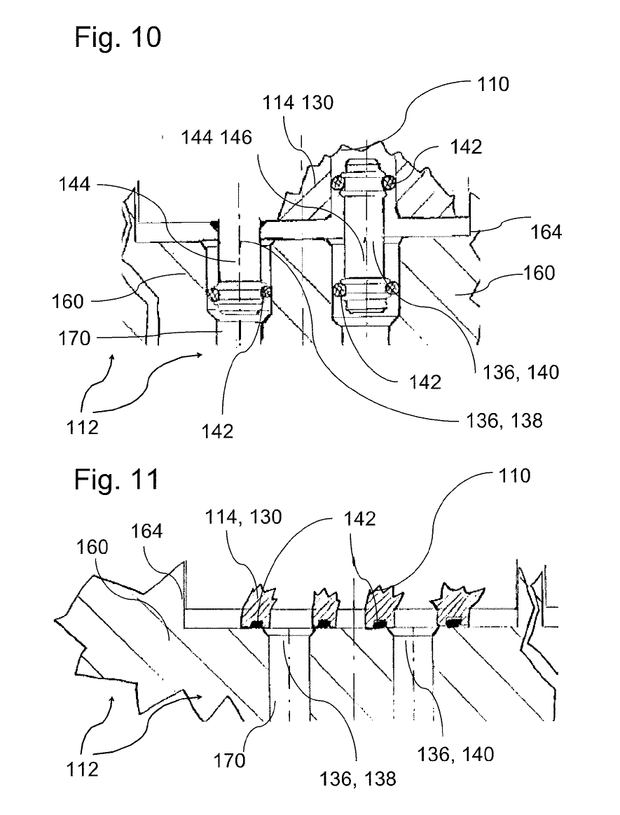

FIGS. 10, 11 and 12 show exemplary fluid interfaces 136 of a fluid supply device 110 and/or a transmission 112. The fluid interface 136 may in particular be configured to seal, in particular to seal fluidically, a fluidic connection 158 between the fluid supply device housing 114 and the transmission casing 160. The fluid interfaces 136 in FIGS. 10, 11 and 12 may preferably have a suction port 138 and a pressure port 140.

FIG. 10 shows a fluid interface 136 which may comprise, at the suction port 138 and/or at the pressure port 140, at least one or at least two O-rings 142 for sealing the fluid interface 136. FIG. 10 shows in particular a radial seal. FIG. 10 shows in particular a fluid interface 136 which may have a connecting piece 144 and a connecting tube 146. The connecting tube 146 may for example be an adapter tube. The O-ring 142 may preferably be arranged at least partially in a groove of the tube and/or of the connecting piece 144. The O-ring 142 may preferably be arranged around the connecting piece 144 and/or around the tube. The O-rings 142 may preferably be arranged substantially perpendicular to a rotation axis 148 of the pump 116. The suction port 138 and/or the pressure port 140 may be oriented substantially parallel to a rotation axis 148 of the pump 116.

FIG. 11 shows a fluid interface 136 which may comprise, at the suction port 138 and/or at the pressure port 140, at least one O-ring 142 for sealing the fluid interface 136. The O-ring 142 may preferably be arranged at least partially in a groove of the fluid supply device housing 114. The O-ring 142 may preferably be arranged around the pressure port 140 and/or around the suction port 138. FIG. 11 shows in particular a fluid interface 136 which may have no connecting piece 144 and no connecting tube 146. The O-rings 142 may preferably be arranged substantially perpendicular to a rotation axis 148 of the pump 116. FIG. 11 shows in particular a fluid interface 136 which may comprise at least one line in the transmission casing 160. The line in the transmission casing 160 may for example be formed at least partially conical at the fluid supply device housing 114, wherein the line in the transmission casing 160 may have a larger diameter at the fluid supply device housing 114 than at a point remote from the fluid supply device housing 114. The suction port 138 and/or the pressure port 140 may be oriented substantially parallel to a rotation axis 148 of the pump 116. FIG. 11 shows in particular a front side seal, for example a housing pot seal, against the transmission casing 160.

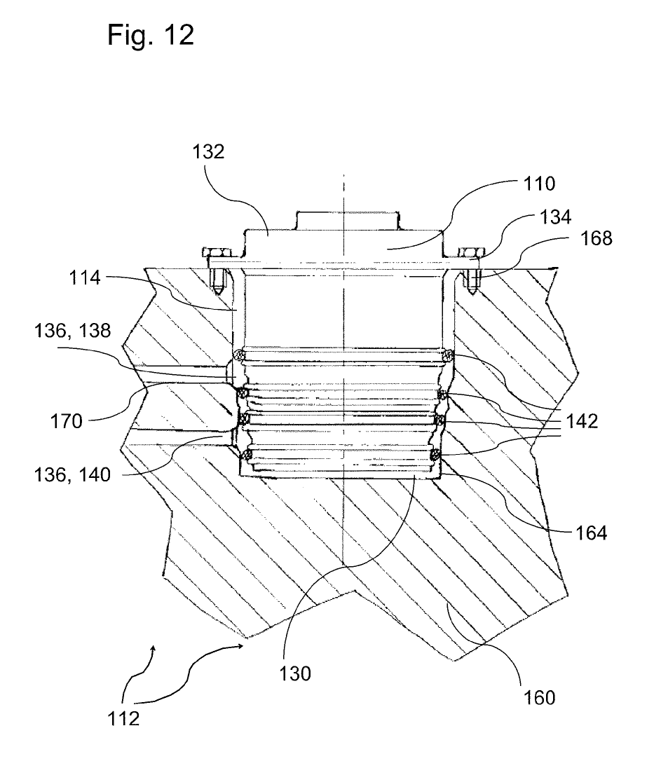

FIG. 12 shows a fluid interface 136 which may comprise, at the suction port 138 and/or at the pressure port 140, at least two O-rings 142 for sealing the fluid interface 136. The fluid supply device housing 114 may have at least two grooves, preferably four grooves. The O-rings 142 may be arranged preferably at least partially in the grooves of the fluid supply device housing 114. The O-rings 142 may preferably be arranged around the fluid supply device housing 114. The O-rings 142 may preferably be arranged substantially perpendicular to a rotation axis 148 of the pump 116. FIG. 12 shows in particular a fluid interface 136 which may have no connecting piece 144 and no connecting tube 146. FIG. 11 shows in particular a fluid interface 136 which may comprise at least one line in the transmission casing 160. The line in the transmission casing 160 may for example be formed at least partially conical at the fluid supply device housing 114, wherein the line in the transmission casing 160 may have a larger diameter at the fluid supply device housing 114 than at a point remote from the fluid supply device housing 114. The suction port 138 and/or the pressure port 140 may be oriented substantially perpendicular to a rotation axis 148 of the pump 116. FIG. 12 shows in particular a radial seal with radial suction port 138 and radial pressure port 140.

Preferably, at least one filter 126, preferably a suction filter 176, may be arranged between the fluid sump 162 and the fluid supply device 110, as shown for example in FIGS. 5 to 8. For example, at least one filter 126, in particular a high-pressure filter 174, may be arranged between the fluid supply device 110 and the clutch 178, as shown for example in FIGS. 6 to 8. For example, the sensor 120, in particular the pressure sensor 122 and/or the temperature sensor 124, may be arranged between the pump 116 and the clutch 178 and/or the filter 126, in particular the high-pressure filter 174, wherein the sensor 120, in particular the pressure sensor 122 and/or the temperature sensor 124, may be arranged inside or outside the fluid supply device housing 114.

In a further aspect, a method is proposed for installing a fluid supply device 110 of a transmission 112 as described above. The fluid supply device 110 is inserted in a transmission casing 160 and at least one fluid interface 136 of the fluid supply device 110 is fluidically connected to the transmission casing 160.

### LIST OF REFERENCE NUMERALS

110 Fluid supply device
112 Transmission
113 Internal rotor
114 Fluid supply device housing
115 External rotor
116 Pump
117 Stator
118 Electric motor
119 Rotor
120 Sensor
121 Electric motor shaft
122 Pressure sensor
123 Suction nodule
124 Temperature sensor
125 Incremental sensor
126 Filter
127 Pressure nodule
128 Electrical unit
129 Cable passage
130 Housing pot
132 Housing cover
134 Closing device
136 Fluid interface
137 Fluid line
138 Suction port
140 Pressure port
142 O-ring
144 Connecting piece
146 Connecting tube
148 Rotation axis of pump
150 Internal leakage
152 External leakage
154 Orifice
156 Intermediate floor
158 Connection
160 Transmission casing
162 Fluid sump
164 Recess
166 Device
168 Fixing device
170 Bore
172 Leakage
174 High-pressure filter
176 Suction filter
178 Clutch
180 Housing part
182 Electric motor housing part
184 Pump housing part
186 Line housing part
188 Valve housing part
190 Valve
192 Plug connector

1. A fluid supply device for a transmission of a motor vehicle, wherein the fluid supply device comprises at least one fluid supply device housing, wherein at least one pump and at least one electric motor are integrated in the fluid supply device housing, wherein the fluid supply device is configured in a modular fashion.

2. The fluid supply device as claimed in claim 1, wherein at least two pumps are integrated in the fluid supply device housing.

3. The fluid supply device as claimed in claim 1, wherein at least one sensor is integrated in the fluid supply device housing.

4. The fluid supply device as claimed in claim 1, wherein at least one filter is integrated in the fluid supply device housing.

5. The fluid supply device as claimed in claim 1, wherein at least one electrical unit is integrated in the fluid supply device housing.

6. The fluid supply device as claimed in claim 1, wherein the fluid supply device housing has at least one housing pot and at least one housing cover, wherein the housing cover is connected to the housing pot.

7. The fluid supply device as claimed in claim 1, wherein the fluid supply device housing has at least two mutually connected housing parts.

8. The fluid supply device as claimed in claim 7, wherein the fluid supply device housing has at least one housing part comprising the electric motor and at least one housing part comprising the pump.

9. The fluid supply device as claimed in claim 1, wherein the fluid supply device comprises at least one fluid interface, wherein the fluid interface has at least one suction port and at least one pressure port, wherein the fluid interface comprises at least one O-ring for sealing the fluid interface.

10. The fluid supply device as claimed in claim 9, wherein the fluid interface has at least one connecting piece.

11. The fluid supply device as claimed in claim 9, wherein at least one of the suction port and the pressure port is oriented substantially parallel to a rotation axis of the pump.

12. The fluid supply device as claimed in claim 1, wherein the fluid supply device comprises at least one internal leakage, wherein the internal leakage has a closed fluid circuit inside at least one of the fluid supply device housing and the pump.

13. The fluid supply device as claimed in claim 12, wherein the internal leakage comprises at least one of at least one orifice, at least one valve, at least one filter and at least one sensor.

14. The fluid supply device as claimed in claim 1, wherein the fluid supply device comprises at least one external leakage.

15. The fluid supply device as claimed in claim 14, wherein the external leakage comprises at least one of at least one orifice, at least one valve, at least one filter and at least one sensor.

16. A transmission for a motor vehicle, wherein the transmission comprises at least one fluid supply device, wherein the transmission comprises at least one fluid sump, wherein the transmission comprises at least one clutch, wherein the fluid supply device comprises at least one fluid supply device housing, wherein at least one pump and at least one electric motor are integrated in the fluid supply device housing, wherein the fluid supply device is configured in a modular fashion, and wherein the fluid device is configured to supply the clutch with fluid from the fluid sump in a controlled fashion.

17. The transmission as claimed in claim 16, wherein the transmission comprises at least one transmission casing, wherein the transmission casing is formed separately from the fluid supply device housing.

18. The transmission as claimed in claim 17, wherein the transmission casing comprises at least one recess, wherein the fluid supply device is received at least partially in the recess.

19. The transmission as claimed in claim 17, wherein at least one O-ring is arranged between the transmission casing and the fluid supply device housing.

20. The transmission as claimed in claim 16, wherein the transmission is a dual clutch transmission.

21. A method for installing a fluid supply device of a transmission, wherein the transmission comprises at least one fluid supply device, at least one fluid sump, and at least one clutch, wherein the fluid supply device is configured to supply the clutch with fluid from the fluid sump in a controlled fashion, the method including the steps of: inserting the fluid supply device in a transmission casing and fluidically connecting at least one fluid interface of the fluid supply device to the transmission casing.
